(19) United States
(12) Patent Application Publication
(10) Pub. No.: US 2017/0023967 A1
(43) Pub. Date: Jan. 26, 2017

(54) VOLTAGE REFERENCE COMPENSATION

(71) Applicant: AnaPrime LLC, San Jose, CA (US)

(72) Inventor: Sang-Soo LEE, Cupertino, CA (US)

(21) Appl. No.: 15/179,064

(22) Filed: Jun. 10, 2016

Related U.S. Application Data
(60) Provisional application No. 62/190,026, filed on Jul. 8, 2015.

(51) Int. Cl. G05F 3/26

(52) U.S. Cl. CPC G05F 3/262

(57) ABSTRACT

In an embodiment, a voltage reference circuit can include a core circuit and an output branch circuit coupled to the core circuit. It is pointed out that the voltage reference circuit is free of bipolar junction transistors.

### CROSS-REFERENCE TO RELATED APPLICATION

This application claims the benefit of U.S. Provisional Patent Application No. 62/190,026, filed Jul. 8, 2015, by Sang-Soo Lee, entitled “CMOS voltage reference with PVT compensation circuits,” which is hereby incorporated by reference.

### BACKGROUND

A bandgap reference circuit or voltage reference circuit can be used to create multiple voltages with different values used in other circuits within a system-on-chip (SoC). As applications for mobile systems including smartphones, wearables, and Internet of Things (IoT) become increasingly popular, it has become desirable to reduce the supply voltage of the SoC below 1 volt (V) to decrease power consumption of the SoC, thereby prolonging the battery life of the overall system. Therefore, it is desirable to design a low voltage reference circuit. Not only that, it has become desirable to design a voltage reference circuit with high accuracy to improve the yield of the SoC in volume production as voltages and currents of the rest of the circuits within the SoC reply on the accuracy of the voltage reference circuit. Therefore, it is commercially beneficial to develop an accurate voltage reference circuit for a supply voltage below 1 V and even reaching as low as 0.7 V. However, the conventional voltage reference circuit using bipolar transistors, resistors, and an operational amplifier (op-amp) can have difficultly generating an accurate reference voltage when the power supply voltage is less than 1 V.

### SUMMARY

Various embodiments in accordance with the present disclosure can address the disadvantages described above by providing a bandgap or voltage reference circuit that generates an accurate reference voltage when the power supply of an integrated circuit (IC) is smaller than 1 V, but is not limited to such.

In various embodiments, the lower voltage operation of a bandgap or voltage reference circuit can be accomplished by utilizing CMOS (complementary metal oxide semiconductor) transistors instead of bipolar transistors as was conventionally done. Furthermore, it is pointed out that the accuracy of the bandgap or voltage reference circuit in various embodiments can be achieved by incorporating one or more compensation circuits and methods into the bandgap or voltage reference circuit to compensate for three primary variation sources, namely PVT (Process, supply Voltage, and Temperature) variations.

In an embodiment, a voltage reference circuit can include a supply voltage compensation circuit. In addition, the voltage reference circuit can include a temperature compensation circuit coupled to the supply voltage compensation circuit. The voltage reference circuit can also include a process corner compensation circuit coupled to the temperature compensation circuit. It is pointed out that the voltage reference circuit is free of bipolar junction transistors.

In another embodiment, a voltage reference circuit can include a supply voltage compensation circuit. The voltage reference circuit can also include a temperature compensation circuit coupled to the supply voltage compensation circuit. Furthermore, the voltage reference circuit can include a process corner compensation circuit coupled to the temperature compensation circuit and the supply voltage compensation circuit. Moreover, the voltage reference circuit is free of bipolar junction transistors.

In yet another embodiment, a voltage reference circuit can include an output branch circuit that includes a process corner compensation circuit. Additionally, the voltage reference circuit can include a supply voltage compensation circuit coupled to the output branch circuit. The voltage reference circuit can also include a temperature compensation circuit coupled to the supply voltage compensation circuit and the output branch circuit. In addition, the voltage reference circuit is free of bipolar junction transistors.

In still another embodiment, a voltage reference circuit can include a core circuit and an output branch circuit coupled to the core circuit. It is pointed out that the voltage reference circuit is free of bipolar junction transistors.

In another embodiment, a voltage reference circuit can include a bandgap core circuit and an output branch circuit coupled to the bandgap core circuit. In addition, the voltage reference circuit can include a process corner compensation circuit coupled to the output branch circuit. It is noted that the voltage reference circuit is free of bipolar junction transistors.

In yet another embodiment, a voltage reference circuit can include a core circuit and an output branch circuit coupled to the core circuit. Note that the output branch circuit can include a process corner compensation circuit. In addition, the voltage reference circuit is free of bipolar junction transistors.

While particular embodiments in accordance with the present disclosure have been specifically described within this Summary, it is noted that the present disclosure and the claimed subject matter are not limited in any way by these embodiments.

### BRIEF DESCRIPTION OF THE DRAWINGS

Within the accompanying drawings, various embodiments in accordance with the present disclosure are illustrated by way of example and not by way of limitation. It is noted that like reference numerals denote similar elements throughout the drawings.

FIG. 1 is a schematic diagram of a bandgap or voltage reference circuit in accordance with various embodiments of the present disclosure.

FIG. 1A is a schematic diagram of another bandgap or voltage reference circuit in accordance with various embodiments of the present disclosure.

FIG. 1B is a schematic diagram of yet another bandgap or voltage reference circuit in accordance with various embodiments of the present disclosure.

FIG. 1C is a schematic diagram of still another bandgap or voltage reference circuit in accordance with various embodiments of the present disclosure.

FIG. 2 is a schematic diagram of a CMOS bandgap core circuit in accordance with various embodiments of the present disclosure.

FIG. 3 is a schematic diagram of a supply voltage compensation circuit in accordance with various embodiments of the present disclosure.

FIG. 4 is a schematic diagram of a process corner compensation circuit in accordance with various embodiments of the present disclosure.

FIG. 5 is a schematic diagram of a temperature compensation circuit in accordance with various embodiments of the present disclosure.

FIG. 5A is a schematic diagram of another temperature compensation circuit in accordance with various embodiments of the present disclosure.

FIG. 6 is a schematic diagram of another bandgap or voltage reference circuit in accordance with various embodiments of the present disclosure.

FIG. 6A is a schematic diagram of yet another bandgap or voltage reference circuit in accordance with various embodiments of the present disclosure.

FIG. 7 is a schematic diagram of another process corner compensation circuit in accordance with various embodiments of the present disclosure.

FIG. 8 is a schematic diagram of yet another bandgap or voltage reference circuit in accordance with various embodiments of the present disclosure.

FIG. 9 is a schematic diagram of still another bandgap or voltage reference circuit in accordance with various embodiments of the present disclosure.

FIG. 9A is a schematic diagram of still another bandgap or voltage reference circuit in accordance with various embodiments of the present disclosure.

FIG. 10 is a schematic diagram of another bandgap or voltage reference circuit in accordance with various embodiments of the present disclosure.

FIG. 10A is a schematic diagram of yet another bandgap or voltage reference circuit in accordance with various embodiments of the present disclosure.

FIG. 10B is a schematic diagram of still another bandgap or voltage reference circuit in accordance with various embodiments of the present disclosure.

FIG. 10C is a schematic diagram of another bandgap or voltage reference circuit in accordance with various embodiments of the present disclosure.

FIG. 11 is a schematic diagram of still another bandgap or voltage reference circuit in accordance with various embodiments of the present disclosure.

FIG. 11A is a schematic diagram of yet another bandgap or voltage reference circuit in accordance with various embodiments of the present disclosure.

FIG. 12 is a schematic diagram of another bandgap or voltage reference circuit in accordance with various embodiments of the present disclosure.

FIG. 12A is a schematic diagram of still another bandgap or voltage reference circuit in accordance with various embodiments of the present disclosure.

FIG. 13 is a schematic diagram of yet another bandgap or voltage reference circuit in accordance with various embodiments of the present disclosure.

FIG. 14 is a schematic diagram of still another bandgap or voltage reference circuit in accordance with various embodiments of the present disclosure.

FIG. 15 is a schematic diagram of another bandgap or voltage reference circuit in accordance with various embodiments of the present disclosure.

FIG. 16 is a schematic diagram of yet another bandgap or voltage reference circuit in accordance with various embodiments of the present disclosure.

FIG. 16A is a schematic diagram of still another bandgap or voltage reference circuit in accordance with various embodiments of the present disclosure.

FIG. 17 is flow diagram of a method in accordance with various embodiments of the present disclosure.

FIG. 18 is a block diagram of an exemplary computing system that may be used in accordance with various embodiments of the present disclosure.

FIG. 19 is a block diagram of an exemplary system-on-chip (SoC) that may be implemented with a bandgap or voltage reference circuit in accordance with various embodiments of the present disclosure.

FIG. 20 is an exemplary voltage regulator circuit that may be implemented with a bandgap or voltage reference circuit in accordance with various embodiments of the present disclosure.

FIG. 21 is an exemplary analog to digital converter (ADC) circuit that may be implemented with a bandgap or voltage reference circuit in accordance with various embodiments of the present disclosure.

The drawings referred to in this description should not be understood as being drawn to scale except if specifically noted.

### DETAILED DESCRIPTION

Reference will now be made in detail to various embodiments in accordance with the present disclosure, examples of which are illustrated in the accompanying drawings. While the present disclosure will be described in conjunction with various embodiments, it will be understood that these various embodiments are not intended to limit the present disclosure. On the contrary, the present disclosure is intended to cover alternatives, modifications and equivalents, which may be included within the scope of the present disclosure as construed according to the Claims. Furthermore, in the following detailed description of various embodiments in accordance with the present disclosure, numerous specific details are set forth in order to provide a thorough understanding of the present disclosure. However, it will be evident to one of ordinary skilled in the art that the present disclosure may be practiced without these specific details or with equivalents thereof. In other instances, well known methods, procedures, components, and circuits have not been described in detail as not to unnecessarily obscure aspects of the present disclosure.

Various embodiments of the present disclosure relate generally to semiconductor integrated circuits, and more particularly to bandgap or voltage reference circuits that can be used in any application-specific integrated circuit (ASIC) or system-on-chip (SoC), but is not limited to such.

More specifically, with the circuit structure, method, and process in accordance with various embodiments, an accurate voltage reference output can be generated when the supply voltage is reduced to as low as 0.7 V, but is not limited to such. It is noted that the low voltage operation of various embodiments can be accomplished by using CMOS (complementary metal oxide semiconductor) transistors as the core elements for the bandgap or voltage reference circuit instead of bipolar transistors.

In addition, excellent accuracy of the bandgap or voltage reference circuit can be achieved by implementing one or more embodiments of the present disclosure to compensate on-chip PVT (Process, supply Voltage, and Temperature) variations. Note that simulation results of a bandgap or voltage reference circuit in accordance with an embodiment show that the accuracy of the output voltage can be improved by a factor of five or more without using any trimming for all process corners when the supply voltage varies as much as ±10% and temperature changes from −40 degrees Celsius (° C.) to 125° C. in 40 nanometer (nm) process technology. When applying trimming to the voltage reference circuit in an embodiment, the variation of the reference voltage over PVT is reduced significantly to as low as ±1%. Furthermore, it is pointed out that a bandgap or voltage reference circuit in accordance with an embodiment can be as much as 5 to 10 times smaller in size than that of the conventional voltage reference circuit using bipolar transistor as core elements.

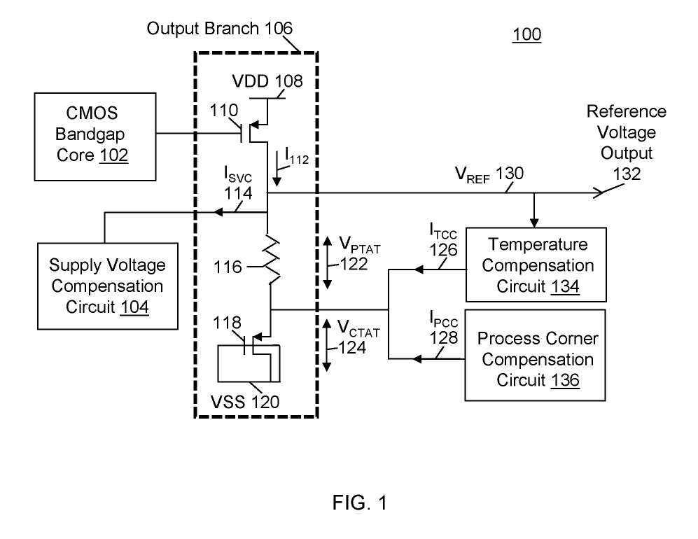

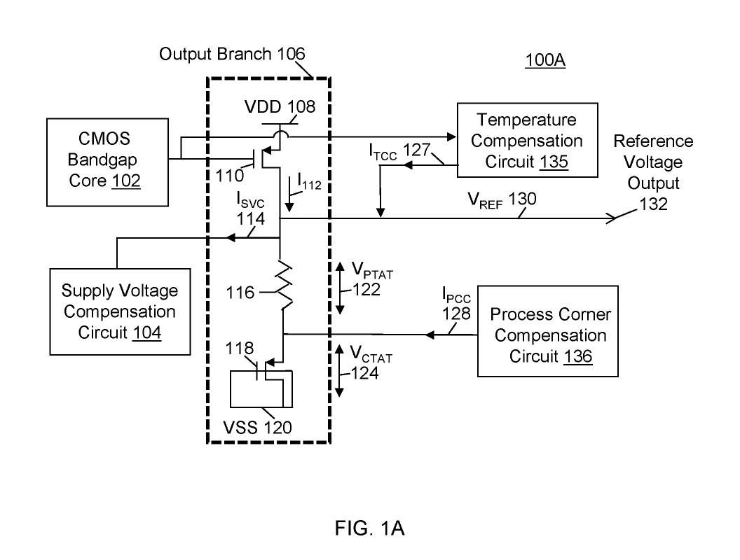

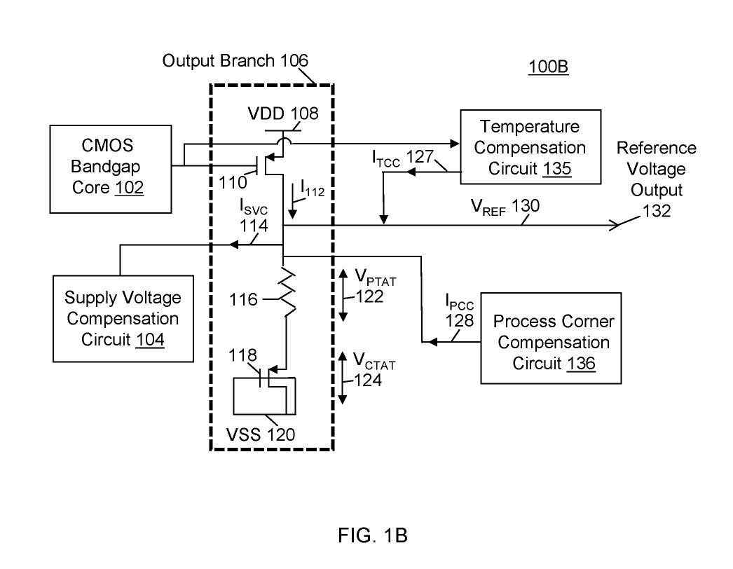

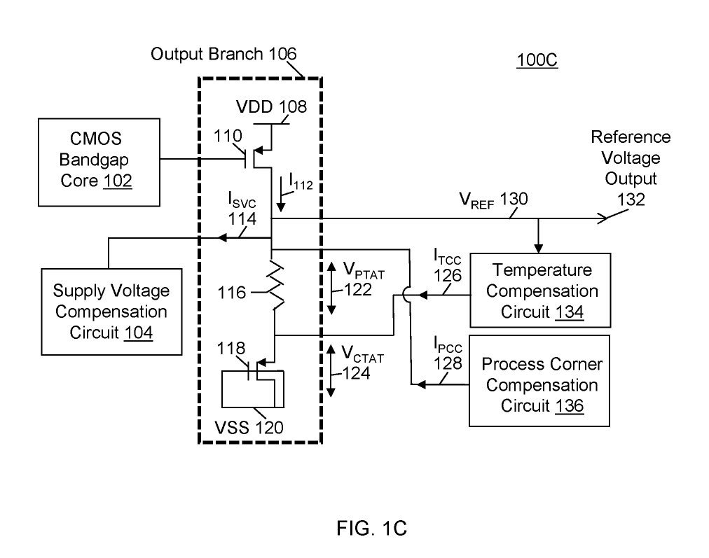

FIG. 1 is a schematic diagram of a bandgap or voltage reference circuit 100 in accordance with various embodiments of the present disclosure. The voltage reference circuit 100 can include, but is not limited to, a CMOS bandgap core circuit 102, an output branch circuit 106, a supply voltage compensation circuit 104, a temperature compensation circuit 134, and a process corner compensation circuit 136. It is noted that the supply voltage compensation circuit 104, the temperature compensation circuit 134, and the process corner compensation circuit 136 are each coupled to the output branch circuit 106 to compensate the PVT (Process, supply Voltage, and Temperature) variations of the voltage reference circuit 100.

Specifically, the supply voltage compensation circuit 104, the temperature compensation circuit 134, and the process corner compensation circuit 136 improve the overall accuracy of the voltage reference circuit 100 by independently compensating the variation components (e.g., supply voltage, temperature, and process corner) one at a time. More specifically, compensation of these variation components (e.g., supply voltage, temperature, and process corner) can be done in the current domain using the compensation currents: a supply voltage compensation current (I_{SVC}) 114, a temperature compensation current (I_{TCC}) 126, and a process corner compensation current (I_{PCC}) 128, respectively. In addition, the voltage reference circuit 100 can include a separate output branch 106 to implement the summation of Voltage Complementary To Absolute Temperature (V_{CTAT}) 124 and Voltage Proportional To Absolute Temperature (V_{PTAT}) 122, which are utilized to produce a reference voltage 130.

In an embodiment, it is noted that the supply voltage compensation circuit 104 can reduce supply voltage induced variation of the voltage reference circuit 100. In addition, the process corner compensation circuit 136 can reduce process corner induced variation of the voltage reference circuit 100. Moreover, the temperature compensation circuit 134 can reduce temperature induced variation of the voltage reference circuit 100.

Within FIG. 1, in an embodiment, it is pointed out that in order to compensate for PVT variations of the MOS transistors of the CMOS bandgap core circuit 102 and the output branch 106, the voltage reference circuit 100 can include the supply voltage compensation circuit 104, the temperature compensation circuit 134, and the process corner compensation circuit 136. Note that the supply voltage compensation circuit 104, the temperature compensation circuit 134, and the process corner compensation circuit 136 can all operate in the current domain. Specifically, the supply voltage compensation circuit 104 can subtract out some current (e.g., I_{SVC} 114) from a node of the output branch 106 coupling the drain of the transistor 110, a first terminal of the resistor 116, an input of the temperature compensation circuit 134, and the reference voltage output 132 to compensate for variation in supply voltage 108. In addition, the temperature compensation circuit 134 and the process corner compensation circuit 136 each add current (e.g., I_{TCC} 126 and I_{PCC} 128, respectively) to the output branch 106 at the node coupling a second terminal of the resistor 116 and the source of the transistor 118 to compensate for temperature and process corner. It is noted that current 112 (I₁₁₂) is the main current of the output branch 106 and the voltage reference circuit 100. In various embodiments, the reference voltage 130 can be bandgap based or based on something else.

In various embodiments, it is pointed out that the voltage reference circuit 100 can be implemented in any application-specific integrated circuit (ASIC), system-on-chip (SoC), voltage regulator circuit, analog to digital (ADC) circuit, or any integrated circuit, but is not limited to such. In various embodiments, it is note that the voltage reference circuit 100 is free of any bipolar junction transistors (BJTs).

Within FIG. 1, in an embodiment, the reference voltage circuit 100 can include the CMOS bandgap core 102, the supply voltage compensation circuit 104, the output branch 106, the temperature compensation circuit 134, and the process corner compensation circuit 136, but is not limited to such. Specifically, the output branch 106 can be coupled with the CMOS bandgap core 102, the supply voltage compensation circuit 104, the temperature compensation circuit 134, and the process corner compensation circuit 136. It is noted that the gate of the transistor 110 of the output branch 106 can be coupled to the CMOS bandgap core 102 and the source of the transistor 110 can be coupled to VDD 108. In addition, the drain of the transistor 110 can be coupled to the supply voltage compensation circuit 104, a first terminal of the resistor 116, an input to the temperature compensation circuit 134, and the reference voltage output 132 of the reference voltage circuit 100. Furthermore, a second terminal of the resistor 116 can be coupled to the source of the transistor 118 and the outputs of the temperature compensation circuit 134 and the process corner compensation circuit 136. It is pointed out that the gate, drain, and body of the transistor 118 can be coupled to VSS 120.

Within FIG. 1, note that each of transistors 110 and 118 can be implemented in a wide variety of ways. In an embodiment, each of the transistors 110 and 118 can be implemented as, but is not limited to, a P-channel MOSFET (metal-oxide semiconductor field-effect transistor) which is also known as a PMOS. Moreover, in an embodiment, each of the transistors 110 and 118 can be implemented as, but is not limited to, an N-channel MOSFET which is also known as an NMOS. Note that the transistors 110 and 118 can be referred to as a current source and a diode, respectively. In an embodiment, it is pointed out that a gate, a drain, and a source of the transistors 110 and 118 can each be referred to as a terminal of its transistor. Moreover, in an embodiment, each gate of the transistors 110 and 118 can also be referred to as a control terminal of its transistor.

It is noted that the reference voltage circuit 100 may not include all of the elements illustrated by FIG. 1. In addition, the reference voltage circuit 100 can be implemented to include one or more elements not illustrated by FIG. 1. It is pointed out that the reference voltage circuit 100 can be utilized or implemented in any manner similar to that described and/or shown by the present disclosure, but is not limited to such.

FIG. 1A is a schematic diagram of a bandgap or voltage reference circuit 100A in accordance with various embodiments of the present disclosure. It is pointed out that the voltage reference circuit 100A illustrates that an output of its temperature compensation circuit (e.g., 135) can be coupled to a different node of the output branch 106 than that shown within the voltage reference circuit 100 of FIG. 1. Note that the voltage reference circuit 100A of FIG. 1A operates in a manner similar to the voltage reference circuit 100 of FIG. 1. However, within the voltage reference circuit 100A, the temperature compensation circuit 135 adds current I_{TCC} 127 to the output branch 106 at the node coupling the drain of the transistor 110, the first terminal of the resistor 116, the reference voltage output 132, and the input of the supply voltage compensation circuit 104 to compensates for temperature.

In an embodiment, an input of the temperature compensation circuit 135 can be coupled to the output of the CMOS bandgap core 102 and the gate of the transistor 110. The output of the temperature compensation circuit 135 can be coupled to the node coupling the drain of the transistor 110, the first terminal of the resistor 116, the reference voltage output 132, and the input of the supply voltage compensation circuit 104. In various embodiments, the remaining components of the voltage reference circuit 100A can be coupled and implemented in any manner similar to that described and/or shown by the voltage reference circuit 100 of FIG. 1, but are not limited to such.

Note that the reference voltage circuit 100A may not include all of the elements illustrated by FIG. 1A. Furthermore, the reference voltage circuit 100A can be implemented to include one or more elements not illustrated by FIG. 1A. It is noted that the reference voltage circuit 100A can be utilized or implemented in any manner similar to that described and/or shown by the present disclosure, but is not limited to such.

FIG. 1B is a schematic diagram of a bandgap or voltage reference circuit 100B in accordance with various embodiments of the present disclosure. Note that the voltage reference circuit 100B illustrates that outputs of its temperature compensation circuit (e.g., 135) and process corner compensation circuit (e.g., 136) can be coupled to a different node of the output branch 106 than that shown within the voltage reference circuit 100 of FIG. 1. It is noted that the voltage reference circuit 100B of FIG. 1B operates in a manner similar to the voltage reference circuit 100 of FIG. 1. However, within the voltage reference circuit 100B, the temperature compensation circuit 135 and the process corner compensation circuit 136 each add current (e.g., I_{TCC} 127 and I_{PCC} 128, respectively) to the output branch 106 at the node coupling the drain of the transistor 110, the first terminal of the resistor 116, the reference voltage output 132, and the input of the supply voltage compensation circuit 104 to compensates for temperature and process corner.

In an embodiment, the output of the process corner compensation circuit 136 can be coupled to the node coupling the drain of the transistor 110, the first terminal of the resistor 116, the reference voltage output 132, and the input of the supply voltage compensation circuit 104. In addition, an input of the temperature compensation circuit 135 can be coupled to the output of the CMOS bandgap core 102 and the gate of the transistor 110. The output of the temperature compensation circuit 135 can be coupled to the node coupling the drain of the transistor 110, the first terminal of the resistor 116, the reference voltage output 132, and the input of the supply voltage compensation circuit 104. In various embodiments, the remaining components of the voltage reference circuit 100B can be coupled and implemented in any manner similar to that described and/or shown by the voltage reference circuit 100 of FIG. 1, but are not limited to such.

It is pointed out that the reference voltage circuit 100B may not include all of the elements illustrated by FIG. 1B. Moreover, the reference voltage circuit 100B can be implemented to include one or more elements not illustrated by FIG. 1B. Note that the reference voltage circuit 100B can be utilized or implemented in any manner similar to that described and/or shown by the present disclosure, but is not limited to such.

FIG. 1C is a schematic diagram of a bandgap or voltage reference circuit 100C in accordance with various embodiments of the present disclosure. It is noted that the voltage reference circuit 100C illustrates that the output of its process corner compensation circuit (e.g., 136) can be coupled to a different node of the output branch 106 than that shown within the voltage reference circuit 100 of FIG. 1. Note that the voltage reference circuit 100C of FIG. 1C operates in a manner similar to the voltage reference circuit 100 of FIG. 1. However, within the voltage reference circuit 100C, the process corner compensation circuit 136 adds current I_{PCC} 128 to the output branch 106 at the node coupling the drain of the transistor 110, the first terminal of the resistor 116, the reference voltage output 132, and the input of the supply voltage compensation circuit 104 to compensates for process corner.

In an embodiment, the output of the process corner compensation circuit 136 can be coupled to the node coupling the drain of the transistor 110, the first terminal of the resistor 116, the reference voltage output 132, and the input of the supply voltage compensation circuit 104. In various embodiments, the remaining components of the voltage reference circuit 100C can be coupled and implemented in any manner similar to that described and/or shown by the voltage reference circuit 100 of FIG. 1, but are not limited to such.

It is noted that the reference voltage circuit 100C may not include all of the elements illustrated by FIG. 1C. Furthermore, the reference voltage circuit 100C can be implemented to include one or more elements not illustrated by FIG. 1C. It is pointed out that the reference voltage circuit 100C can be utilized or implemented in any manner similar to that described and/or shown by the present disclosure, but is not limited to such.

As shown within FIGS. 1, 1A, 1B, and 1C, the outputs of a temperature compensation circuit (e.g., 134 or 135) and a process corner compensation circuit (e.g., 136) of a voltage reference circuit in accordance with an embodiment of the present disclosure can be coupled to the output branch 106 anywhere between the drain of the transistor 110 and the source of the transistor 118.

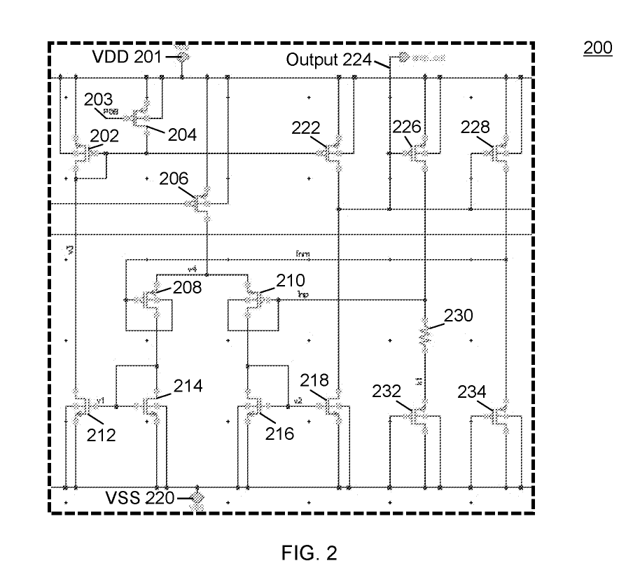

FIG. 2 is a schematic diagram of a CMOS bandgap core circuit 200 in accordance with various embodiments of the present disclosure. It is noted that in various embodiments, the CMOS bandgap core circuit 200 can be utilized for implementing the CMOS bandgap core circuit 102 of the voltage reference circuits 100, 100A, 100B, and 100C of FIGS. 1, 1A, 1B, and 1C, respectively, but is not limited to such.

It is pointed out that transistors 202, 204, 206, 208, 210, 212, 214, 216, 218 and 222 are an operational amplifier (op-amp) of the CMOS bandgap core circuit 200. Furthermore, output 224 is both the output of the operational amplifier and also the output of the CMOS bandgap core circuit 200. In an embodiment, the output 224 of the CMOS bandgap core circuit 200 can be coupled to the gate of the transistor 110 of the output branch 106. Besides the operational amplifier, the CMOS bandgap core circuit 200 can include, but is not limited to, a first branch made up of resistor 230 along with transistors 226 and 232 and a second branch made up of transistors 228 and 234. It is noted that the combination of the op-amp, the first branch and the second branch creates an output voltage 224 that can be used to generate a Proportional-To-Absolute-Temperature (PTAT) current when the output is coupled to the gate of PMOS transistors (e.g., 110). Therefore, the currents through transistors 226 and 228 and the current through the transistor 110 of the output branch 106 have PTAT characteristics. In an embodiment, note that the CMOS bandgap core circuit 200 is free of any bipolar junction transistors (BJTs).

Within FIG. 2, in an embodiment, the CMOS bandgap core circuit 200 can include the transistors 202, 204, 206, 208, 210, 212, 214, 216, 218, 222, 226, 228, 232, and 234 along with the resistor 230, but is not limited to such. Specifically, the source and body of the transistor 202 can be coupled to VDD 201. The gate of the transistor 202 can be coupled to its drain, the drain of the transistor 204, the gate of the transistor 222, and the drain of the transistor 212. Furthermore, the source and body of the transistor 204 can be coupled to VDD 201 while its gate can be coupled to a Power Down Bar (PDB) 203 to power down the CMOS bandgap core circuit 200 in a power saving mode. The source and body of the transistor 222 can be coupled to VDD 201. The source and body of the transistor 212 can be coupled to VSS 220 while its gate can be coupled to the gate and drain of the transistor 214 and the drain of the transistor 208. The source and body of the transistor 214 can be coupled to VSS 220.

In addition, the gate and body of the transistor 208 can be coupled to the source of the transistor 234 and the drain of the transistor 228. The source of the transistor 208 can be coupled to the drain of the transistor 206 and the source of the transistor 210. The source and body of the transistor 206 can be coupled to VDD 201 while its gate can be coupled to the gate of another transistor (not shown) to provide current to operate the CMOS bandgap core circuit 200. The gate and body of the transistor 210 can be coupled to a first terminal of the resistor 230 and the drain of the transistor 226. The drain of the transistor 210 can be coupled to the gate of the transistor 218 and the gate and drain of the transistor 216. The source and body of each of the transistors 216 and 218 can be coupled to VSS 220. The drain of the transistor 218 can be coupled to the drain of the transistor 222, the gates of transistors 226 and 228, and the output 224. The source and body of each of the transistors 226 and 228 can be coupled to VDD 201. The gate, drain, and body of the transistor 234 can be coupled to VSS 220. A second terminal of the resistor 230 can be coupled to the source of the transistor 232 while the gate, drain, and body of the transistor 233 can be coupled to VSS 220.

Within FIG. 2, note that each of the transistors 202, 204, 206, 208, 210, 212, 214, 216, 218, 222, 226, 228, 232, and 234 can be implemented in a wide variety of ways. For example, in an embodiment, the body of the transistor 208 can be coupled to the source of the transistor 208 or VDD 201 instead of the gate of the transistor 208. Also, the body of the transistor 210 can be coupled to the source of the transistor 210 or VDD 201 instead of the gate of the transistor 210. In an embodiment, each of the transistors 202, 204, 206, 208, 210, 222, 226, 228, 232, and 234 can be implemented as, but is not limited to, a P-channel MOSFET which is also known as a PMOS. In addition, in an embodiment, each of the transistors 212, 214, 216, and 218 can be implemented as, but is not limited to, an N-channel MOSFET which is also known as an NMOS. It is noted that each of the transistors 202, 204, 206, 208, 210, 212, 214, 216, 218, 222, 226, 228, 232, and 234 can be implemented as, but is not limited to, a PMOS or NMOS. Note that each of the transistors 202, 204, 206, 208, 210, 212, 214, 216, 218, 222, 226, 228, 232, and 234 can be referred to as a switching element. In an embodiment, it is pointed out that a gate, a drain, and a source of the transistors 202, 204, 206, 208, 210, 212, 214, 216, 218, 222, 226, 228, 232, and 234 can each be referred to as a terminal of its transistor. Furthermore, in an embodiment, each gate of the transistors 202, 204, 206, 208, 210, 212, 214, 216, 218, 222, 226, 228, 232, and 234 can also be referred to as a control terminal of its transistor.

It is understood that the CMOS bandgap core circuit 200 may not include all of the elements illustrated by FIG. 2. Additionally, the CMOS bandgap core 200 can be implemented to include one or more elements not illustrated by FIG. 2. It is pointed out that the CMOS bandgap core 200 can be utilized or implemented in any manner similar to that described and/or shown by the present disclosure, but is not limited to such.

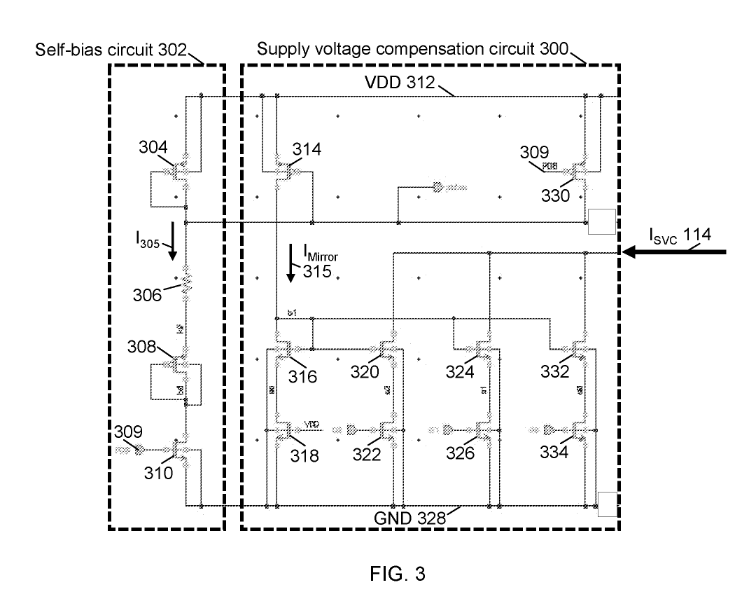

FIG. 3 is a schematic diagram of a supply voltage compensation circuit 300 in accordance with various embodiments of the present disclosure. Note that the supply voltage compensation circuit 300 can be implemented to operate with and include a self-bias circuit 302, but is not limited to such. It is pointed out that in various embodiments, the supply voltage compensation circuit 300 can be utilized for implementing the supply voltage compensation circuit 104 of the voltage reference circuits 100, 100A, 100B, and 100C of FIGS. 1, 1A, 1B, and 1C, respectively, but is not limited to such. In an embodiment, note that the supply voltage compensation circuit 300 is free of any bipolar junction transistors (BJTs). The supply voltage compensation circuit 300 can compensate the output voltage variation due to power supply 312 changes of a voltage reference circuit (e.g., 100) in accordance with various embodiments.

Specifically, in an embodiment, the supply voltage compensation circuit 300 can produce a current related to the changes in supply voltage using a self-bias circuit 302 and then removes more or less current (I_{SVC}) 114 from the main output branch current (I₁₁₂) 112 when the supply voltage 312 is high or low, respectively. Note that together with the self-bias circuit 302, the supply voltage compensation circuit 300 can subtract scaled current (I_{SVC}) 114 that is proportional to supply voltage 312 from the main output branch current (I₁₁₂) 112. Specifically, in an embodiment, when the supply voltage 312 changes, the amount of current (I_{SVC}) 114 that is taken out by the supply voltage compensation circuit 300 from the output branch 106 changes.

Within FIG. 3, in various embodiments, when the supply voltage compensation circuit 300 is implemented to operate with and includes the self-bias circuit 302, a current 305 that flows through the self bias circuit 302 is mirrored into a branch of the supply voltage compensation circuit 300 as mirror current (Iₘᵢᵣᵣₒᵣ) 315. It is noted that the mirror current 315 is multiplied by a current scalar of one or more of the programmable branches of the supply voltage compensation circuit 300. Therefore, a properly scaled current (I_{SVC}) 114 can be removed from the main current (I₁₁₂) 112 of the output branch 106.

As mentioned above, the supply voltage compensation circuit 300 can include one or more programmable branches, but is not limited to such. For example, within the present embodiment, a first programmable branch can include transistors 320 and 322, a second programmable branch can include transistors 324 and 326, and a third programmable branch can include transistors 332 and 334. In various embodiments, each of the programmable branches can be programmed (e.g., turned on or off) via an input bit to each gate of the transistors 322, 326, and 334 during the manufacturing and testing of each die and can be fixed for each die. It is pointed out that each programmable branch can be implemented to scale current by a different factor, but is not limited to such. For example, in an embodiment, the first programmable branch can be implemented to scale current by a factor of 1, the second programmable branch can be implemented to scale current by a factor of 2, and the third programmable branch can be implemented to scale current by a factor of 4, but are not limited by such. It is noted that the supply voltage compensation circuit 300 described herein is equivalent to a 3-bit Digital-to-Analog Converter (DAC), but is not limited to such. Continuing with example, by programming different combinations of bits, one or more of the programmable branches can remove different amounts of current 114.

Within FIG. 3, in an embodiment, the supply voltage compensation circuit 300 can include the transistors 314, 316, 318, 320, 322, 324, 326, 330, 332, and 334, but is not limited to such. Specifically, the source and body of the transistor 314 can be coupled to VDD 312 while its gate can be coupled to the drain of the transistor 330. The drain of the transistor 314 can be coupled to the gates of the transistors 316, 320, 324, and 332 along with the drain of the transistor 316. The bodies of the transistors 316 and 318 along with the source of the transistor 318 can be coupled to the ground 328. The source of the transistor 316 can be coupled to the drain of the transistor 318 while the gate of the transistor 318 can be coupled to VDD 312. In addition, the drains of the transistors 320, 324, and 332 can be coupled together and can also be coupled to the output branch 106 of FIG. 1. The bodies of the transistors 320 and 322 along with the source of the transistor 322 can be coupled to the ground 328.

The source of the transistor 320 can be coupled to the drain of the transistor 322 while the gate of the transistor 322 can be coupled to a programming input or interface (not shown) for turning on or off transistor 322. The bodies of the transistors 324 and 326 along with the source of the transistor 326 can be coupled to the ground 328. The source of the transistor 324 can be coupled to the drain of the transistor 326 while the gate of the transistor 326 can be coupled to a programming input or interface (not shown) for turning on or off transistor 326. The bodies of the transistors 332 and 334 along with the source of the transistor 334 can be coupled to the ground 328. The source of the transistor 332 can be coupled to the drain of the transistor 334 while the gate of the transistor 334 can be coupled to a programming input or interface (not shown) for turning on or off transistor 334. The source and body of the transistor 330 can be coupled to VDD 312 while its gate can be coupled to a Power Down Bar (PDB) 309 to power down the supply voltage compensation circuit 300 in a power saving mode.

Within FIG. 3, in various embodiments, the supply voltage compensation circuit 300 can be implemented to include and operate with the elements of the self-bias circuit 302 which can include the transistors 304, 308, and 310 along with the resistor 306, but is not limited to such. Specifically, the source and body of the transistor 304 can be coupled to VDD 312. The gate of the transistor 304 can be coupled to its drain and a first terminal of the resistor 306, and the gates of the transistors 314 and 330. A second terminal of the resistor 306 can be coupled to the source of the transistor 308 while the gate, drain, and body of the transistor 308 can be coupled to the drain of the transistor 310. The source and body of the transistor 310 can be coupled to the ground 328 while its gate can be coupled to the PDB (or a power down signal) 309 in a power saving mode.

Note that each of the transistors 304, 308, 310, 314, 316, 318, 320, 322, 324, 326, 330, 332, and 334 can be implemented in a wide variety of ways. In an embodiment, each of the transistors 304, 308, 314, and 330 can be implemented as, but is not limited to, a P-channel MOSFET which is also known as a PMOS. Moreover, in an embodiment, each of the transistors 310, 316, 318, 320, 322, 324, 326, 332, and 334 can be implemented as, but is not limited to, an N-channel MOSFET which is also known as an NMOS. It is noted that each of the transistors 304, 308, 310, 314, 316, 318, 320, 322, 324, 326, 330, 332, and 334 can be implemented as, but is not limited to, a PMOS or NMOS. Note that each of the transistors 304, 308, 310, 314, 316, 318, 320, 322, 324, 326, 330, 332, and 334 can be referred to as a switching element. In an embodiment, it is noted that a gate, a drain, and a source of the transistors 304, 308, 310, 314, 316, 318, 320, 322, 324, 326, 330, 332, and 334 can each be referred to as a terminal of its transistor. Additionally, in an embodiment, each gate of the transistors 304, 308, 310, 314, 316, 318, 320, 322, 324, 326, 330, 332, and 334 can also be referred to as a control terminal of its transistor.

It is understood that the supply voltage compensation circuit 300 and the self-bias circuit 302 may not include all of the elements illustrated by FIG. 3. For example, in an embodiment the transistor 308 can be omitted to couple the second terminal of the resistor 306 directly to the drain of the transistor 310. Furthermore, in an embodiment the transistor 310 can be omitted to couple the drain of the transistor 308 directly to the ground 328 in applications where power saving mode is not desired. Additionally, the supply voltage compensation circuit 300 and the self-bias circuit 302 can each be implemented to include one or more elements not illustrated by FIG. 3. It is pointed out that the supply voltage compensation circuit 300 and the self-bias circuit 302 can be utilized or implemented in any manner similar to that described and/or shown by the present disclosure, but is not limited to such.

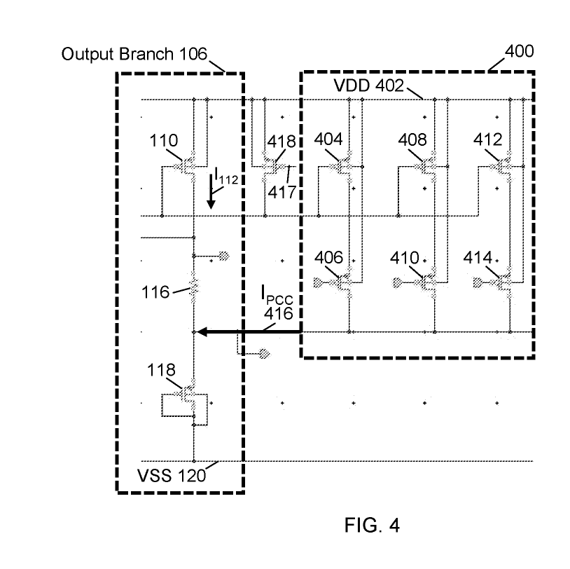

FIG. 4 is a schematic diagram of a process corner compensation circuit 400 in accordance with various embodiments of the present disclosure. Note that in various embodiments, the process corner compensation circuit 400 can be utilized for implementing the process corner compensation circuit 136 of the voltage reference circuits 100, 100A, 100B, and 100C of FIGS. 1, 1A, 1B, and 1C, respectively, but is not limited to such. In an embodiment, note that the process corner compensation circuit 400 is free of any bipolar junction transistors (BJTs). The process corner compensation circuit 400 can compensate process corner variation of a voltage reference circuit (e.g., 100) in accordance with an embodiment.

Specifically, the process corner compensation circuit 400 can operate by injecting additional programmable current (I_{PCC}) 416 to the main transistor 118 of the output branch 106 to compensate the process corner variation. For example, when the process corner is slow, the threshold voltage of the transistor 118 is high. Therefore, the output voltage 130 will be already high without the compensation. In that case, the process corner compensation circuit 400 can be programmed to add minimal or no additional current to the main transistor 118 to limit the voltage increase due to additional current injected from the programmable current sources of the process compensation circuit 400. On the other hand, when the process corner is fast, the threshold voltage of the transistor 118 will be low thereby resulting in low output voltage. In this case, the process corner compensation circuit 400 can be programmed to add more current to the main transistor 118 thereby increasing the output voltage 130 to the target value when the process is fast. Note that when the process corner compensation circuit 400 injects more current into transistor 118, more voltage is created across transistor 118.

Within FIG. 4, the process corner compensation circuit 400 can include one or more programmable branches, but is not limited to such. For example, within the present embodiment, a first programmable branch can include transistors 404 and 406, a second programmable branch can include transistors 408 and 410, and a third programmable branch can include transistors 412 and 414. In various embodiments, each of the programmable branches can be programmed (e.g., turned on or off) via an input bit to each gate of the transistors 406, 410, and 414 during the manufacturing and testing of each die and can be fixed for each die. For example, in various embodiments, in the manufacturing environment the output reference voltage 130 can be measured of the voltage reference circuit 100. To increase or decrease the level of the output reference voltage 130, injection of current can be increased or decreased into the output branch 106. Note that each programmable branch can be implemented to scale current by a different factor, but is not limited to such. For example, in an embodiment, the first programmable branch can be implemented to scale current by a factor of 1, the second programmable branch can be implemented to scale current by a factor of 2, and the third programmable branch can be implemented to scale current by a factor of 4, but are not limited by such. Continuing with the example, by programming different combinations of bits, one or more of the programmable branches of the process corner compensation circuit 400 can scale the amount of current 416 injected into the transistor 118 of the output branch 106.

Within FIG. 4, in an embodiment, the process corner compensation circuit 400 can include the transistors 404, 406, 408, 410, 412, and 414, but is not limited to such. Specifically, the source and body of the transistor 404 along with the body of the transistor 406 can be coupled to VDD 402. The drain of the transistor 404 can be coupled to the source of the transistor 406 while the gate of the transistor 404 can be coupled to the gates of the transistors 408 and 412. The source and body of the transistor 408 along with the body of the transistor 410 can be coupled to VDD 402. The drain of the transistor 408 can be coupled to the source of the transistor 410. The source and body of the transistor 412 along with the body of the transistor 414 can be coupled to VDD 402. The drain of the transistor 412 can be coupled to the source of the transistor 414.

The gates of the transistors 406, 410, and 414 can each be coupled to a programming input or interface (not shown) for turning on or off each of the transistor 406, 410, and 414. The drains of the transistors 406, 410, and 414 can be coupled to the output branch 106 of FIG. 1. For example, in an embodiment, the drains of the transistors 406, 410, and 414 can be coupled to the second terminal of the resistor 116 of the output branch 106 and the source of the transistor 118 of the output branch 106. In addition, in an embodiment, the gates of the transistors 404, 408, and 412 of the process corner compensation circuit 400 can be coupled to the output branch 106 of FIG. 1. For example, in an embodiment, the gates of the transistors 404, 408, and 412 can be coupled to the gate of the transistor 110 of the output branch 106. Note that the source and body of the transistor 110 can be coupled to VDD 402. Furthermore, in an embodiment, the gates of the transistors 404, 408, and 412 of the process corner compensation circuit 400 can be coupled to the drain of a transistor 418 which is coupled to the gate of the transistor 110. The source and body of the transistor 418 can be coupled to VDD 402 while its gate can be coupled to a power down signal 417.

Within FIG. 4, it is noted that each of the transistors 404, 406, 408, 410, 412, 414, and 418 can be implemented in a wide variety of ways. In an embodiment, each of the transistors 404, 406, 408, 410, 412, 414, and 418 can be implemented as, but is not limited to, a P-channel MOSFET which is also known as a PMOS, to produce a PMOS DAC (Digital-to-Analog Converter). Moreover, in an embodiment, each of the transistors 404, 406, 408, 410, 412, 414, and 418 can be implemented as, but is not limited to, an N-channel MOSFET which is also known as an NMOS to produce an NMOS DAC (Digital-to-Analog Converter). Note that each of the transistors 404, 406, 408, 410, 412, 414, and 418 can be referred to as a switching element. In an embodiment, it is noted that a gate, a drain, and a source of the transistors 404, 406, 408, 410, 412, 414, and 418 can each be referred to as a terminal of its transistor. Additionally, in an embodiment, each gate of the transistors 404, 406, 408, 410, 412, 414, and 418 can also be referred to as a control terminal of its transistor.

It is understood that the process corner compensation circuit 400 may not include all of the elements illustrated by FIG. 4. Furthermore, the process corner compensation circuit 400 can be implemented to include one or more elements not illustrated by FIG. 4. It is noted that the process corner compensation circuit 400 can be utilized or implemented in any manner similar to that described and/or shown by the present disclosure, but is not limited to such. For example, in various embodiments, the process corner compensation circuit 400 can include both PMOS DAC and NMOS DAC. Furthermore, in various embodiments, the programmable current (I_{PCC}) 416 can be injected into the first terminal of the resistor 116 instead of the second terminal of the resistor 116 as shown in FIGS. 1B and 1C.

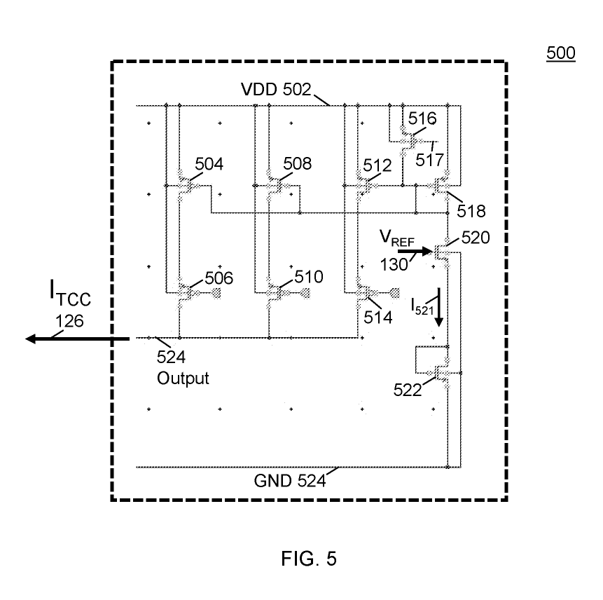

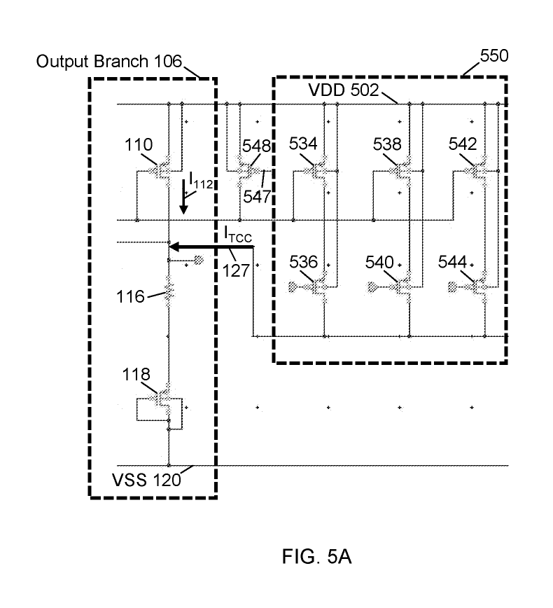

FIG. 5 is a schematic diagram of a temperature compensation circuit 500 in accordance with various embodiments of the present disclosure. It is noted that in various embodiments, the temperature compensation circuit 500 can be utilized for implementing the temperature compensation circuit 134 of the voltage reference circuits 100 and 100C of FIGS. 1 and 1C, respectively, but is not limited to such. In an embodiment, note that the temperature compensation circuit 500 is free of any bipolar junction transistors (BJTs). It is pointed out that the temperature compensation circuit 500 can operate by injecting a scaled current I_{TCC} 126 that is related to temperature and process corner into the main transistor 118 of the output branch 106 of the voltage reference circuit 100. Since its effect is stronger when the temperature is high, it can be referred to as the temperature compensation circuit 500. However, the temperature compensation circuit 500 also improves process corner variation since slow corner produces less compensation current, I_{TCC} 126, whereas fast corner produces more compensation current I_{TCC} 126. Therefore, the temperature compensation circuit 500 naturally compensates process corner because the larger current in fast corner will increase the output voltage whereas the smaller current in slow corner reduces the output voltage.

Note that the temperature compensation circuit 500 can be equivalent to a process monitor to detect the process corner. With the temperature compensation circuit 500 integrated in a voltage reference circuit (e.g., 100), it can achieve the dual goal of compensating process corner and temperature effect in one circuit. It is pointed out that since the input to the temperature compensation circuit 500 can be the reference voltage V_{REF} 130 of the voltage reference circuit 100, the temperature compensation circuit 500 is not affected by power supply variation. Therefore, the temperature compensation circuit 500 is able to inject a scaled version of the compensation current I_{TCC} 126 that depends on the process corner and temperature variations, and not on power supply variation.

Within FIG. 5, the master branch of the temperature compensation circuit 500 can include transistors 518, 520, and 522. A current 521 in the master branch is created based on the reference voltage 130 that is input into the gate of the transistor 520 of the temperature compensation circuit 500. Therefore, the master branch will create the current 521 which depends on the process corner and temperature of transistor 520. For example, at a higher temperature there is more current 521, which is mirrored and scaled by the one or more programmable branches of the temperature compensation circuit 500 thereby generating a current (I_{TCC}) 126 that can be injected into the output branch 106.

The temperature compensation circuit 500 can include one or more programmable branches, but is not limited to such. For example, within the present embodiment, a first programmable branch can include transistors 504 and 506, a second programmable branch can include transistors 508 and 510, and a third programmable branch can include transistors 512 and 514. In various embodiments, each of the programmable branches can be programmed (e.g., turned on or off) via an input bit to each gate of the transistors 506, 510, and 514 during the manufacturing and testing of each die and can be fixed for each die. For example, in various embodiments, in the manufacturing environment the output reference voltage 130 can be measured of the voltage reference circuit 100. To increase or decrease the level of the output reference voltage 130, injection of current can be increased or decreased into the output branch 106. It is noted that each programmable branch can be implemented to scale the mirrored current by a different factor, but is not limited to such. For example, in an embodiment, the first programmable branch can be implemented to scale current by a factor of 1, the second programmable branch can be implemented to scale current by a factor of 2, and the third programmable branch can be implemented to scale current by a factor of 4, but are not limited by such. Continuing with the example, by programming different combinations of bits, one or more of the programmable branches of the temperature compensation circuit 500 can scale the amount of current 126 injected into the transistor 118 of the output branch 106.

Note that the gates of transistors 506, 510 and 514 would be coupled to a programmer input or interface (not shown) to program the scaling of the mirrored current. In various embodiments, it is point out that the temperature compensation circuit 500 is generally more effective at high temperatures, but is not limited to such.

Within FIG. 5, in an embodiment, the temperature compensation circuit 500 can include the transistors 504, 506, 508, 510, 512, 514, 516, 518, 520, and 522, but is not limited to such. Specifically, the source and body of the transistor 504 along with the body of the transistor 506 can be coupled to VDD 502. The drain of the transistor 504 can be coupled to the source of the transistor 506. The gate of the transistor 504 can be coupled to the gates of the transistors 508, 512, and 518 along with the drains of the transistors 516, 518, and 520. The source and body of the transistor 508 along with the body of the transistor 510 can be coupled to VDD 502. The drain of the transistor 508 can be coupled to the source of the transistor 510. The source and body of the transistor 512 along with the body of the transistor 514 can be coupled to VDD 502.

The drain of the transistor 512 can be coupled to the source of the transistor 514. The drains of the transistors 506, 510, and 514 can be coupled to an output 524 of the temperature compensation circuit 500. The gate of each of the transistors 506, 510, and 514 can be coupled to a programming input or interface (not shown) for turning on or off each of the transistor 506, 510, and 514. The source and body of the transistor 516 can be coupled to VDD 502 while the gate of the transistor 516 can be coupled to a power down control signal 517. The source and body of the transistor 518 can be coupled to VDD 502. In an embodiment, the gate of the transistor 520 can be coupled to the output branch 106 of FIG. 1 to receive the reference voltage 130. The source and body of the transistor 522 along with the body of the transistor 520 can be coupled to ground 524. The gate and drain of the transistor 522 can be coupled to the source of the transistor 520.

Within FIG. 5, it is noted that each of the transistors 504, 506, 508, 510, 512, 514, 516, 518, 520, and 522 can be implemented in a wide variety of ways. In an embodiment, each of the transistors 504, 506, 508, 510, 512, 514, 516, and 518 can be implemented as, but is not limited to, a P-channel MOSFET which is also known as a PMOS, to produce a PMOS DAC (Digital-to-Analog Converter). In addition, in an embodiment, each of the transistors 520 and 522 can be implemented as, but is not limited to, an N-channel MOSFET which is also known as an NMOS, to produce an NMOS DAC (Digital-to-Analog Converter). In another embodiment, the transistor 520 can be implemented as an NMOS and the transistor 522 can be implemented as a PMOS so that the PMOS and NMOS combination could reduce slow-fast or fast-slow corner effect. It is noted that each of the transistors 504, 506, 508, 510, 512, 514, 516, 518, 520, and 522 can be implemented as, but is not limited to, a PMOS or NMOS. Note that each of the transistors 504, 506, 508, 510, 512, 514, 516, 518, 520, and 522 can be referred to as a switching element. In an embodiment, it is noted that a gate, a drain, and a source of the transistors 504, 506, 508, 510, 512, 514, 516, 518, 520, and 522 can each be referred to as a terminal of its transistor. Moreover, in an embodiment, each gate of the transistors 504, 506, 508, 510, 512, 514, 516, 518, 520, and 522 can also be referred to as a control terminal of its transistor.

It is understood that the temperature compensation circuit 500 may not include all of the elements illustrated by FIG. 5. Additionally, the temperature compensation circuit 500 can be implemented to include one or more elements not illustrated by FIG. 5. Note that the temperature compensation circuit 500 can be utilized or implemented in any manner similar to that described and/or shown by the present disclosure, but is not limited to such. For example, in various embodiments, the temperature compensation circuit 500 can include both PMOS DAC and NMOS DAC.

FIG. 5A is a schematic diagram of a temperature compensation circuit 550 in accordance with various embodiments of the present disclosure. It is noted that in various embodiments, the temperature compensation circuit 550 can be utilized for implementing the temperature compensation circuit 135 of the voltage reference circuit 100A of FIG. 1A and the voltage reference circuit 100B of FIG. 1B, but is not limited to such. In an embodiment, note that the temperature compensation circuit 550 is free of any bipolar junction transistors (BJTs). It is pointed out that the temperature compensation circuit 550 can operate by injecting a scaled current I_{TCC} 127 that is related to temperature variation into the node coupling the drain of the transistor 110, the first terminal of the resistor 116, the reference voltage output 132, and the input of the supply voltage compensation circuit 104 of the output branch 106 of the voltage reference circuit 100A or 100B. Since the temperature compensation circuit 550 derives its input from the output of the bandgap core 102 of FIG. 1A and FIG. 1B, the scaled current I_{TCC} 127 has Proportional-To-Absolute-Temperature (PTAT) characteristic. Therefore, by injecting more or less current into the output branch 106, it changes the temperature slope of the bandgap output voltage since the voltage drop across the resistor 116 is modulated by the programmable current.

Note that the temperature compensation circuit 550 operates in a manner similar to a process corner compensation circuit 400 described in FIG. 4 in that they both inject programmable currents into the output branch 106 except the difference in the coupling node. Unlike the process corner compensation circuit 400 that is injecting the current directly into the second terminal of resistor 116 in the output branch 106, the temperature compensation circuit 550 is injecting the programmable current into the first terminal of resistor 116 to change the temperature slope of the voltage drop across the resistor 116.

Within FIG. 5A, the temperature compensation circuit 550 can include one or more programmable branches, but is not limited to such. For example, within the present embodiment, a first programmable branch can include transistors 534 and 536, a second programmable branch can include transistors 538 and 540, and a third programmable branch can include transistors 542 and 544. In various embodiments, each of the programmable branches can be programmed (e.g., turned on or off) via an input bit to each gate of the transistors 536, 540, and 544 during the manufacturing and testing of each die and can be fixed for each die. For example, in various embodiments, in the manufacturing environment the output reference voltage 130 can be measured of the voltage reference circuit 100A or 100B. To increase or decrease the level of the output reference voltage 130, injection of current can be increased or decreased into the output branch 106. Note that each programmable branch can be implemented to scale current by a different factor, but is not limited to such. For example, in an embodiment, the first programmable branch can be implemented to scale current by a factor of 4, the second programmable branch can be implemented to scale current by a factor of 2, and the third programmable branch can be implemented to scale current by a factor of 1, but are not limited by such. Continuing with the example, by programming different combinations of bits, one or more of the programmable branches of the temperature compensation circuit 550 can scale the amount of current 127 injected into the node coupling the drain of the transistor 110, the first terminal of the resistor 116, the reference voltage output 132, and the input of the supply voltage compensation circuit 104 of the output branch 106.

It is noted that the gates of transistors 536, 540 and 544 can be coupled to a programming input or interface (not shown) to program the scaling of the current 127. This construction is equivalent to a 3-bit Digital-to-Analog Converter (DAC), but is not limited to such.

Within FIG. 5A, in an embodiment, the temperature compensation circuit 550 can include the transistors 534, 536, 538, 540, 542, and 544, but is not limited to such. Specifically, the source and body of the transistor 534 along with the body of the transistor 536 can be coupled to VDD 502. The drain of the transistor 534 can be coupled to the source of the transistor 536 while the gate of the transistor 534 can be coupled to the gates of the transistors 538 and 542. The source and body of the transistor 538 along with the body of the transistor 540 can be coupled to VDD 502. The drain of the transistor 408 can be coupled to the source of the transistor 410. The source and body of the transistor 542 along with the body of the transistor 544 can be coupled to VDD 502. The drain of the transistor 542 can be coupled to the source of the transistor 544.

The gates of the transistors 536, 540, and 544 can each be coupled to a programming input or interface (not shown) for turning on or off each of the transistor 536, 540, and 544. The drains of the transistors 536, 540, and 544 can be coupled to the output branch 106 of FIG. 1B or 1C. For example, in an embodiment, the drains of the transistors 536, 540, and 544 can be coupled to the node coupling the drain of the transistor 110, the first terminal of the resistor 116, the reference voltage output 132, and the input of the supply voltage compensation circuit 104 of the output branch 106 of the voltage reference circuit 100A or 100B. In addition, in an embodiment, the gates of the transistors 534, 538, and 542 of the temperature compensation circuit 550 can be coupled to the output branch 106 of FIG. 1B or 1C. For example, in an embodiment, the gates of the transistors 534, 538, and 542 can be coupled to the gate of the transistor 110 of the output branch 106. It is noted that the source and body of the transistor 110 can be coupled to VDD 502. In addition, in an embodiment, the gates of the transistors 534, 538, and 542 of the temperature compensation circuit 550 can be coupled to the drain of a transistor 548 which is coupled to the gate of the transistor 110. The source and body of the transistor 548 can be coupled to VDD 502 while its gate can be coupled to a power down signal 547.

Within FIG. 5A, it is noted that each of the transistors 534, 536, 538, 540, 542, 544, and 548 can be implemented in a wide variety of ways. In an embodiment, each of the transistors 534, 536, 538, 540, 542, 544, and 548 can be implemented as, but is not limited to, a P-channel MOSFET which is also known as a PMOS to produce a PMOS DAC (Digital-to-Analog Converter). Furthermore, in an embodiment, each of the transistors 534, 536, 538, 540, 542, 544, and 548 can be implemented as, but is not limited to, an N-channel MOSFET which is also known as an NMOS to produce an NMOS DAC (Digital-to-Analog Converter). It is noted that each of the transistors 534, 536, 538, 540, 542, 544, and 548 can be referred to as a switching element. In an embodiment, note that a gate, a drain, and a source of the transistors 534, 536, 538, 540, 542, 544, and 548 can each be referred to as a terminal of its transistor. In addition, in an embodiment, each gate of the transistors 534, 536, 538, 540, 542, 544, and 548 can also be referred to as a control terminal of its transistor.

It is understood that the temperature compensation circuit 550 may not include all of the elements illustrated by FIG. 5A. Moreover, the temperature compensation circuit 550 can be implemented to include one or more elements not illustrated by FIG. 5A. It is noted that the temperature compensation circuit 550 can be utilized or implemented in any manner similar to that described and/or shown by the present disclosure, but is not limited to such. For example, in various embodiments, the temperature compensation circuit 550 can include both PMOS DAC and NMOS DAC.

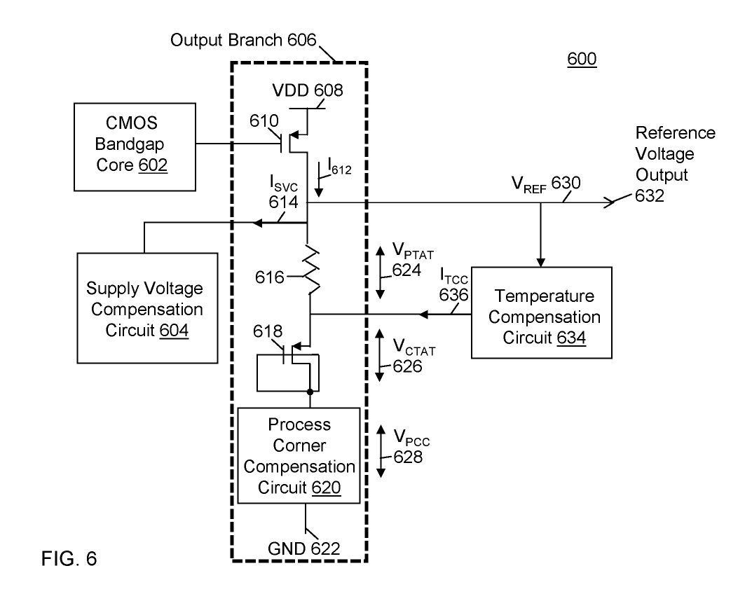

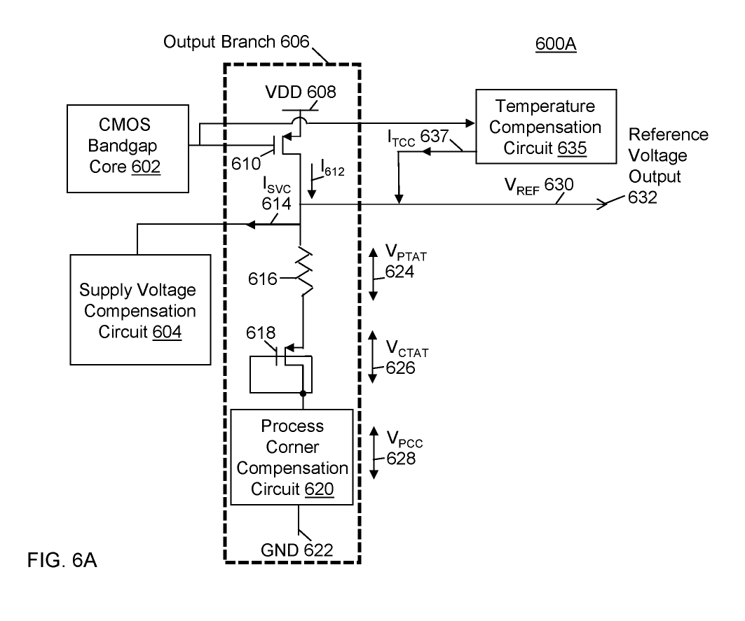

FIG. 6 is a schematic diagram of another bandgap or voltage reference circuit 600 in accordance with various embodiments of the present disclosure. It is pointed out that the bandgap or voltage reference circuit 600 is based on voltage domain compensation for the process corner variation. Unlike the voltage reference circuit 100 of FIG. 1, a process corner compensation circuit 620 of the voltage reference circuit 600 can be implemented at the bottom of an output branch 606 so that the voltage domain summation can be achieved by adding appropriate programmable voltage depending on the process corner. In an embodiment, note that the reference voltage circuit 600 is free of any bipolar junction transistors (BJTs).

Within the reference voltage circuit 600, the process corner compensation circuit 620 adds voltage (V_{PCC}) 628 at the bottom of the output branch 606. Note that the amount of additional voltage 628 that is added by the process corner compensation circuit 620 depends upon the process corner. In addition, the separate output branch 606 can be utilized to implement the summation of Voltage Complementary To Absolute Temperature (V_{CTAT}) 626 and Voltage Proportional To Absolute Temperature (V_{PTAT}) 624 with the voltage (V_{PCC}) 628 of the process corner compensation circuit 620, which are utilized to produce a reference voltage 630.

Within FIG. 6, note that the supply voltage compensation circuit 604, the temperature compensation circuit 634, and the process corner compensation circuit 620 improve the overall accuracy of the voltage reference circuit 600 by independently compensating the variation components (e.g., supply voltage, temperature, and process corner) one at a time. Note that the supply voltage compensation circuit 604 and the temperature compensation circuit 634 can operate in the current domain. Specifically, the supply voltage compensation circuit 604 can subtract out some current (e.g., I_{SVC} 614) from a node of the output branch 606 coupling the drain of the transistor 610, a first terminal of the resistor 616, an input of the temperature compensation circuit 634, and the reference voltage output 632 to compensate for variation in supply voltage 608. In addition, the temperature compensation circuit 634 can add current (e.g., I_{TCC} 636) to the output branch 606 at the node coupling a second terminal of the resistor 616 and the source of the transistor 618 to compensate for temperature. It is noted that current 612 (I₆₁₂) is the main current of the output branch 606 and the voltage reference circuit 600. In various embodiments, the reference voltage 630 can be bandgap based or based on something else.

In various embodiments, the reference voltage circuit 600 of FIG. 6 consumes less power than the reference voltage circuit 100 of FIG. 1. Specifically, in an embodiment, the reference voltage circuit 100 creates more current resulting in more power consumption. Conversely, the reference voltage circuit 600 does not consume any more current because it uses the current 612 of the output branch 606 to develop the voltage 628 of the process corner compensation circuit 620. However, in various embodiments, the reference voltage circuit 100 can utilize a lower supply voltage (VDD) and can result in a smaller size than the reference voltage circuit 600.

Within FIG. 6, it is noted that in various embodiments, the CMOS bandgap core circuit 602, the supply voltage compensation circuit 604, and the temperature compensation circuit 634 can each be implemented in a wide variety of ways. For example, in various embodiments, the CMOS bandgap core circuit 200 of FIG. 2 can be utilized for implementing the CMOS bandgap core circuit 602, but is not limited to such. In addition, in various embodiments, the supply voltage compensation circuit 300 of FIG. 3 can be utilized for implementing the supply voltage compensation circuit 604, but is not limited to such. Moreover, in various embodiments, the temperature compensation circuit 500 of FIG. 5 can be utilized for implementing the temperature compensation circuit 634, but is not limited to such.

In various embodiments, it is pointed out that the voltage reference circuit 600 can be implemented in any application-specific integrated circuit (ASIC), system-on-chip (SoC), voltage regulator circuit, analog to digital (ADC) circuit, or any integrated circuit, but is not limited to such.

Within FIG. 6, in an embodiment, the reference voltage circuit 600 can include the CMOS bandgap core 602, the supply voltage compensation circuit 604, the temperature compensation circuit 634, the output branch 606, and the process corner compensation circuit 620, but is not limited to such. Note that the output branch 606 can be implemented to include the process corner compensation circuit 620. The output branch 606 can be coupled with the CMOS bandgap core 602, the supply voltage compensation circuit 604, and the temperature compensation circuit 634. It is noted that the gate of the transistor 610 of the output branch 606 can be coupled to the CMOS bandgap core 602 and the source of the transistor 610 can be coupled to VDD 608. Furthermore, the drain of the transistor 610 can be coupled to the supply voltage compensation circuit 604, a first terminal of the resistor 616, an input to the temperature compensation circuit 634, and the reference voltage output 632 of the reference voltage circuit 600. Additionally, a second terminal of the resistor 616 can be coupled to the source of the transistor 618 and the output of the temperature compensation circuit 634. The gate, drain, and body of the transistor 618 can be coupled to the process corner compensation circuit 620. The process corner compensation circuit 620 can be coupled to VSS or ground 622.

Within FIG. 6, it is noted that each of transistors 610 and 618 can be implemented in a wide variety of ways. In an embodiment, each of the transistors 610 and 618 can be implemented as, but is not limited to, a P-channel MOSFET which is also known as a PMOS. Moreover, in an embodiment, each of the transistors 610 and 618 can be implemented as, but is not limited to, an N-channel MOSFET which is also known as an NMOS. It is pointed out that each of the transistors 610 and 618 can be referred to as a switching element. In an embodiment, note that a gate, a drain, and a source of the transistors 610 and 618 can each be referred to as a terminal of its transistor. Additionally, in an embodiment, each gate of the transistors 610 and 618 can also be referred to as a control terminal of its transistor.

Note that the reference voltage circuit 600 may not include all of the elements illustrated by FIG. 6. Furthermore, the reference voltage circuit 600 can be implemented to include one or more elements not illustrated by FIG. 6. It is pointed out that the reference voltage circuit 600 can be utilized or implemented in any manner similar to that described and/or shown by the present disclosure, but is not limited to such.

FIG. 6A is a schematic diagram of a bandgap or voltage reference circuit 600A in accordance with various embodiments of the present disclosure. It is pointed out that the voltage reference circuit 600A illustrates that an output of its temperature compensation circuit (e.g., 635) can be coupled to a different node of the output branch 606 than that shown within the voltage reference circuit 600 of FIG. 6. Note that the voltage reference circuit 600A of FIG. 6A operates in a manner similar to the voltage reference circuit 600 of FIG. 6. However, within the voltage reference circuit 600A, the temperature compensation circuit 635 adds current I_{TCC} 637 to the output branch 606 at the node coupling the drain of the transistor 610, the first terminal of the resistor 616, the reference voltage output 632, and the input of the supply voltage compensation circuit 604 to compensates for temperature.

In an embodiment, an input of the temperature compensation circuit 635 can be coupled to the output of the CMOS bandgap core 602 and the gate of the transistor 610. The output of the temperature compensation circuit 635 can be coupled to the node coupling the drain of the transistor 610, the first terminal of the resistor 616, the reference voltage output 632, and the input of the supply voltage compensation circuit 604. In various embodiments, the temperature compensation circuit 550 of FIG. 5A can be utilized for implementing the temperature compensation circuit 635, but is not limited to such. In various embodiments, the remaining components of the voltage reference circuit 600A can be coupled and implemented in any manner similar to that described and/or shown by the voltage reference circuit 600 of FIG. 6, but are not limited to such.

Note that the reference voltage circuit 600A may not include all of the elements illustrated by FIG. 6A. Furthermore, the reference voltage circuit 600A can be implemented to include one or more elements not illustrated by FIG. 6A. It is noted that the reference voltage circuit 600A can be utilized or implemented in any manner similar to that described and/or shown by the present disclosure, but is not limited to such.

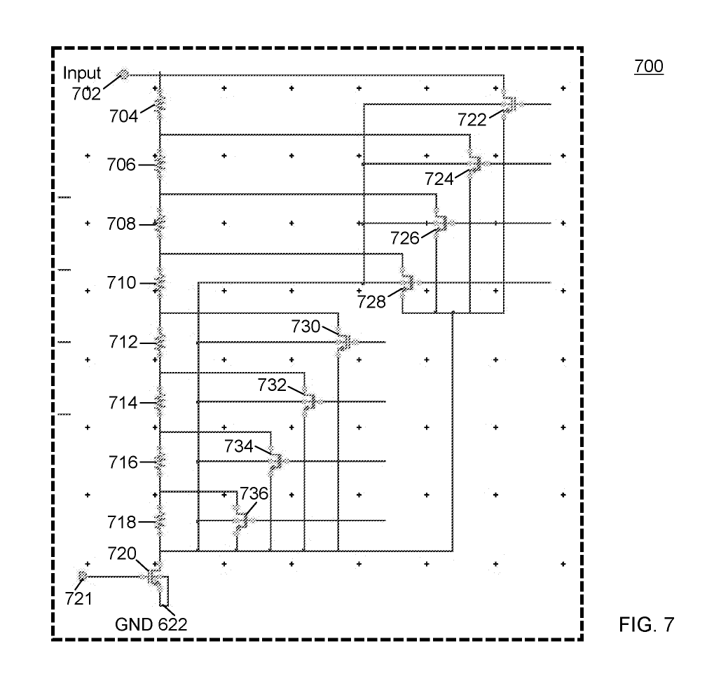

FIG. 7 is a schematic diagram of another process corner compensation circuit 700 in accordance with various embodiments of the present disclosure. Note that in various embodiments, the process corner compensation circuit 700 can be utilized for implementing the process corner compensation circuit 620 of the voltage reference circuit 600 of FIG. 6 and the voltage reference circuit 600A of FIG. 6A, but is not limited to such. In an embodiment, note that the process corner compensation circuit 700 is free of any bipolar junction transistors (BJTs). It is noted that the process corner compensation circuit 700 can be a programmable process corner compensation circuit. Specifically, the process corner compensation circuit 700 can be programmed via the appropriate one or more transistors depending upon the process corner.

In various embodiments, the process corner compensation circuit 700 can include a resistor string its input 702 and ground 622. Within the present embodiment, the resistor string can include resistors 704, 706, 708, 710, 712, 714, 716, and 718, but is not limited to such. Note that transistors 720, 722, 724, 726, 728, 730, 732, 734, and 736 of the process corner compensation circuit 700 can each be a programmable switch. Specifically, the process corner compensation circuit 700 can include a resistor string with programmable tap points to ground 622. In various embodiments, each of the transistors 720, 722, 724, 726, 728, 730, 732, 734, and 736 can be programmed (e.g., turned on or off) via an input bit to each gate of the transistors 720, 722, 724, 726, 728, 730, 732, 734, and 736 during the manufacturing and testing of each die and can be fixed for each die. For example, in various embodiments, in the manufacturing environment the output reference voltage 630 can be measured of the voltage reference circuit 600 or 600A. Consequently, the voltage 628 across the process corner compensation circuit 700 can be increased or decreased by increasing of decreasing the resistance of the process corner compensation circuit 700 by programming one or more of the transistors 720, 722, 724, 726, 728, 730, 732, 734, and 736.

Within FIG. 7, in an embodiment, the process corner compensation circuit 700 can include the resistors 704, 706, 708, 710, 712, 714, 716, and 718 along with transistors 720, 722, 724, 726, 728, 730, 732, 734, and 736, but is not limited to such. Specifically, in an embodiment, an input 702 of the process corner compensation circuit 700 can be coupled with the gate, drain, and body of the transistor 618 of the output branch 606 of FIG. 6 or 6A. The input 702 of the process corner compensation circuit 700 can be coupled to a first terminal of the resistor 704 and the drain of the transistor 722. A second terminal of the resistor 704 can be coupled to a first terminal of the resistor 706 and the drain of the transistor 724. A second terminal of the resistor 706 can be coupled to a first terminal of the resistor 708 and the drain of the transistor 726.

In addition, a second terminal of the resistor 708 can be coupled to a first terminal of the resistor 710 and the drain of the transistor 728. A second terminal of the resistor 710 can be coupled to a first terminal of the resistor 712 and the drain of the transistor 730. In addition, a second terminal of the resistor 712 can be coupled to a first terminal of the resistor 714 and the drain of the transistor 732. A second terminal of the resistor 714 can be coupled to a first terminal of the resistor 716 and the drain of the transistor 734. A second terminal of the resistor 716 can be coupled to a first terminal of the resistor 718 and the drain of the transistor 736. A second terminal of the resistor 718 can be coupled to the drain of the transistor 720 and the sources and bodies of the transistors 722, 724, 726, 728, 730, 732, 734, and 736. The gates of the transistors 722, 724, 726, 728, 730, 732, 734, and 736 can each of coupled to a programming input or interface (not shown) for turning on or off each of the transistor 722, 724, 726, 728, 730, 732, 734, and 736. The source and body of the transistor 720 can be coupled to ground (e.g., 622) while its gate can be coupled to a power down signal 721.

Within FIG. 7, note that each of the transistors 720, 722, 724, 726, 728, 730, 732, 734, and 736 can be implemented in a wide variety of ways. In an embodiment, each of the transistors 720, 722, 724, 726, 728, 730, 732, 734, and 736 can be implemented as, but is not limited to, an N-channel MOSFET which is also known as an NMOS. In addition, in an embodiment, each of the transistors 720, 722, 724, 726, 728, 730, 732, 734, and 736 can be implemented as, but is not limited to, a P-channel MOSFET which is also known as a PMOS. Note that each of the transistors 720, 722, 724, 726, 728, 730, 732, 734, and 736 can be referred to as a switching element. In an embodiment, it is pointed out that a gate, a drain, and a source of the transistors 720, 722, 724, 726, 728, 730, 732, 734, and 736 can each be referred to as a terminal of its transistor. Moreover, in an embodiment, each gate of the transistors 720, 722, 724, 726, 728, 730, 732, 734, and 736 can also be referred to as a control terminal of its transistor.

It is pointed out that the process corner compensation circuit 700 may not include all of the elements illustrated by FIG. 7. Furthermore, the process corner compensation circuit 700 can be implemented to include one or more elements not illustrated by FIG. 7. Note that the process corner compensation circuit 700 can be utilized or implemented in any manner similar to that described and/or shown by the present disclosure, but is not limited to such.

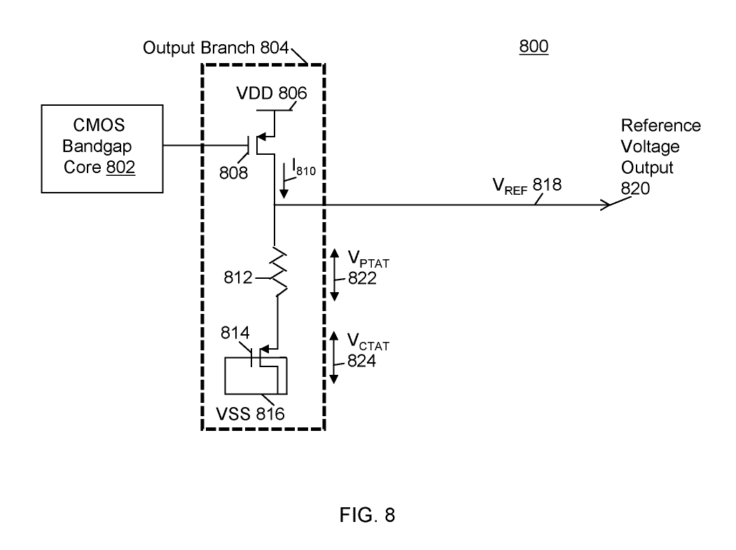

FIG. 8 is a schematic diagram of a bandgap or voltage reference circuit 800 in accordance with various embodiments of the present disclosure. The voltage reference circuit 800 can include, but is not limited to, a CMOS bandgap core circuit 802 and an output branch circuit 804. Note that a current 810 (I₈₁₀) is the main current of the output branch circuit 804 and the voltage reference circuit 800. The voltage reference circuit 800 can include a separate output branch 804 to implement the summation of Voltage Complementary To Absolute Temperature (V_{CTAT}) 824 and Voltage Proportional To Absolute Temperature (V_{PTAT}) 822, which are utilized to produce a reference voltage 818. In various embodiments, the reference voltage (V_{REF}) 818 of the voltage reference circuit 800 can be bandgap based or based on something else.

In various embodiments, it is pointed out that the voltage reference circuit 800 can be implemented in any application-specific integrated circuit (ASIC), system-on-chip (SoC), voltage regulator circuit, analog to digital (ADC) circuit, or any integrated circuit, but is not limited to such. In various embodiments, it is note that the voltage reference circuit 800 is free of any bipolar junction transistors (BJTs).

Within FIG. 8, it is noted that in various embodiments, the CMOS bandgap core circuit 802 can be implemented in a wide variety of ways. For example, in various embodiments, the CMOS bandgap core circuit 200 of FIG. 2 can be utilized for implementing the CMOS bandgap core circuit 802, but is not limited to such.

In an embodiment, the reference voltage circuit 800 can include the CMOS bandgap core 802 and the output branch 804, but is not limited to such. Specifically, the output branch 804 can be coupled with the CMOS bandgap core 802. Note that the gate of the transistor 808 of the output branch 804 can be coupled to the CMOS bandgap core 802 and the source of the transistor 808 can be coupled to VDD 806. In addition, the drain of the transistor 808 can be coupled to a first terminal of the resistor 812 and the reference voltage output 820 of the reference voltage circuit 800. Additionally, a second terminal of the resistor 812 can be coupled to the source of the transistor 814. It is noted that the gate, drain, and body of the transistor 814 can be coupled to VSS (or ground) 816.

Within FIG. 8, note that each of transistors 808 and 814 can be implemented in a wide variety of ways. In an embodiment, each of the transistors 808 and 814 can be implemented as, but is not limited to, a P-channel MOSFET which is also known as a PMOS. Furthermore, in an embodiment, each of the transistors 808 and 814 can be implemented as, but is not limited to, an N-channel MOSFET which is also known as an NMOS. Note that the transistors 808 and 814 can be referred to as a current source and a diode, respectively. In an embodiment, it is pointed out that a gate, a drain, and a source of the transistors 808 and 814 can each be referred to as a terminal of its transistor. In addition, in an embodiment, each gate of the transistors 808 and 814 can also be referred to as a control terminal of its transistor.

Note that the reference voltage circuit 800 may not include all of the elements illustrated by FIG. 8. In addition, the reference voltage circuit 800 can be implemented to include one or more elements not illustrated by FIG. 8. It is pointed out that the reference voltage circuit 800 can be utilized or implemented in any manner similar to that described and/or shown by the present disclosure, but is not limited to such.

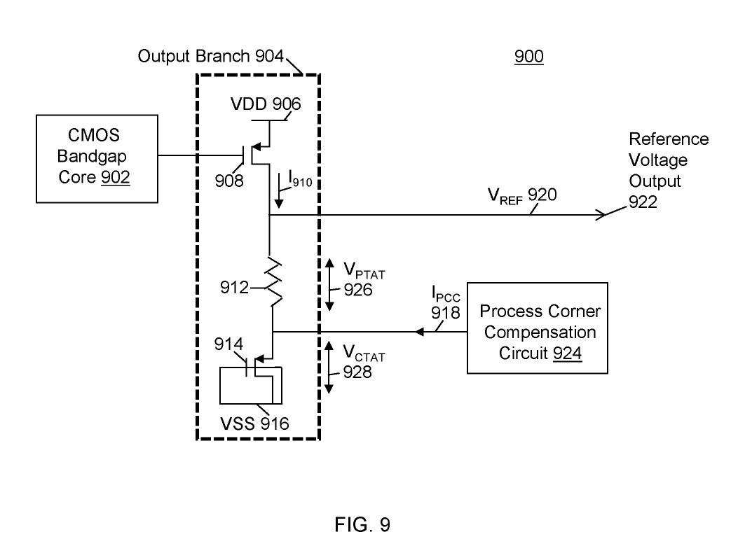

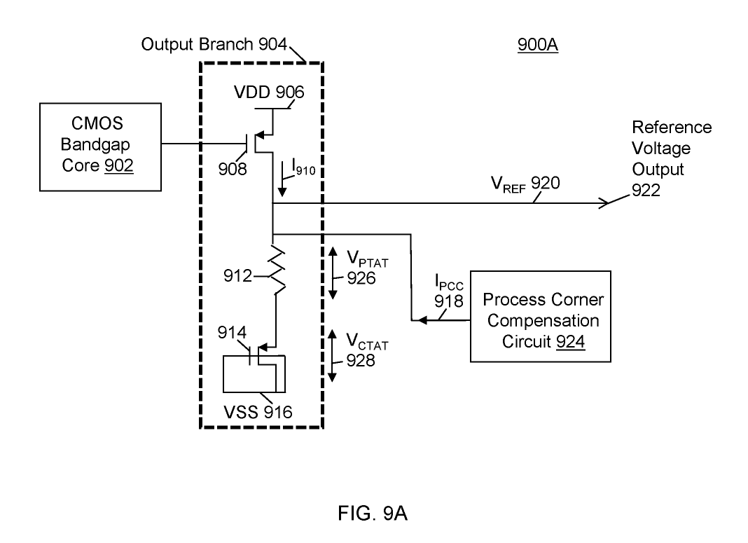

FIG. 9 is a schematic diagram of a bandgap or voltage reference circuit 900 in accordance with various embodiments of the present disclosure. The voltage reference circuit 900 can include, but is not limited to, a CMOS bandgap core circuit 902, an output branch circuit 904, and a process corner compensation circuit 924. It is noted that the process corner compensation circuit 924 is coupled to the output branch circuit 904 to compensate the process variations of the voltage reference circuit 900. Note that one benefit of the voltage reference circuit 900 is its reduced size which results in reducing the cost of fabricating it.

Specifically, the process corner compensation circuit 924 improves the overall accuracy of the voltage reference circuit 900 by independently compensating for the process corner. More specifically, compensation of the process corner can be done in the current domain using a process corner compensation current (I_{PCC}) 918 produced by the process corner compensation circuit 924. In an embodiment, it is noted that the process corner compensation circuit 924 can reduce process corner induced variation of the voltage reference circuit 900. Note that the voltage reference circuit 900 can include a separate output branch 904 to implement the summation of Voltage Complementary To Absolute Temperature (V_{CTAT}) 928 and Voltage Proportional To Absolute Temperature (V_{PTAT}) 926, which are utilized to produce a reference voltage 920.

Within FIG. 9, in an embodiment, note that in order to compensate for process corner variations of the MOS transistors of the CMOS bandgap core circuit 902 and the output branch 904, the voltage reference circuit 900 can include the process corner compensation circuit 924. As previously noted, the process corner compensation circuit 924 can operate in the current domain. Specifically, the process corner compensation circuit 924 can add current (e.g., I_{PCC} 918) to the output branch 904 at the node coupling a second terminal of the resistor 912 and the source of the transistor 914 to compensate for process corner variation. Note that current 910 (I₉₁₀) is the main current of the output branch 904 and the voltage reference circuit 900. The reference voltage 920 is output from the voltage reference circuit 900 via the reference voltage output 922. In various embodiments, the reference voltage 920 can be bandgap based or based on something else.

In various embodiments, it is pointed out that the voltage reference circuit 900 can be implemented in any application-specific integrated circuit (ASIC), system-on-chip (SoC), voltage regulator circuit, analog to digital (ADC) circuit, or any integrated circuit, but is not limited to such. In various embodiments, it is note that the voltage reference circuit 900 is free of any bipolar junction transistors (BJTs).

Within FIG. 9, note that in various embodiments, the CMOS bandgap core circuit 902 and the process corner compensation circuit 924 can each be implemented in a wide variety of ways. For example, in various embodiments, the CMOS bandgap core circuit 200 of FIG. 2 can be utilized for implementing the CMOS bandgap core circuit 902, but is not limited to such. Additionally, in various embodiments, the process corner compensation circuit 400 of FIG. 4 can be utilized for implementing the process corner compensation circuit 924, but is not limited to such.

In an embodiment, the reference voltage circuit 900 can include the CMOS bandgap core 902, the output branch 904, and the process corner compensation circuit 924, but is not limited to such. Specifically, the output branch 906 can be coupled with the CMOS bandgap core 902 and the process corner compensation circuit 924. The gate of the transistor 908 of the output branch 904 can be coupled to the CMOS bandgap core 902 and the source of the transistor 908 can be coupled to VDD 906. The drain of the transistor 908 can be coupled to a first terminal of the resistor 912 and the reference voltage output 922 of the reference voltage circuit 900. In addition, a second terminal of the resistor 912 can be coupled to the source of the transistor 914 and the output of the process corner compensation circuit 918. Note that the gate, drain, and body of the transistor 914 can be coupled to VSS (or ground) 916.

Within FIG. 9, it is noted that each of transistors 908 and 914 can be implemented in a wide variety of ways. In an embodiment, each of the transistors 908 and 914 can be implemented as, but is not limited to, a P-channel MOSFET which is also known as a PMOS. In an embodiment, each of the transistors 908 and 914 can be implemented as, but is not limited to, an N-channel MOSFET which is also known as an NMOS. The transistors 908 and 914 can be referred to as a current source and a diode, respectively. In an embodiment, note that a gate, a drain, and a source of the transistors 908 and 914 can each be referred to as a terminal of its transistor. In an embodiment, each gate of the transistors 908 and 914 can also be referred to as a control terminal of its transistor.

Note that the reference voltage circuit 900 may not include all of the elements illustrated by FIG. 9. Moreover, the reference voltage circuit 900 can be implemented to include one or more elements not illustrated by FIG. 9. It is pointed out that the reference voltage circuit 900 can be utilized or implemented in any manner similar to that described and/or shown by the present disclosure, but is not limited to such.

FIG. 9A is a schematic diagram of a bandgap or voltage reference circuit 900A in accordance with various embodiments of the present disclosure. It is pointed out that the voltage reference circuit 900A illustrates that an output of its process corner compensation circuit (e.g., 924) can be coupled to a different node of the output branch 904 than that shown within the voltage reference circuit 900 of FIG. 9. Note that the voltage reference circuit 900A of FIG. 9A operates in a manner similar to the voltage reference circuit 900 of FIG. 9. However, within the voltage reference circuit 900A, the process corner compensation circuit 924 adds current I_{PCC} 918 to the output branch 904 at the node coupling the drain of the transistor 908, the first terminal of the resistor 912, and the reference voltage output 922 to compensates for process corner.

In an embodiment, the output of the process corner compensation circuit 924 can be coupled to the node coupling the drain of the transistor 908, the first terminal of the resistor 912, and the reference voltage output 922. In an embodiment, the remaining components of the voltage reference circuit 900A can be coupled and implemented in any manner similar to that described and/or shown by the voltage reference circuit 900 of FIG. 9, but are not limited to such.

Note that the reference voltage circuit 900A may not include all of the elements illustrated by FIG. 9A. In addition, the reference voltage circuit 900A can be implemented to include one or more elements not illustrated by FIG. 9A. It is pointed out that the reference voltage circuit 900A can be utilized or implemented in any manner similar to that described and/or shown by the present disclosure, but is not limited to such.

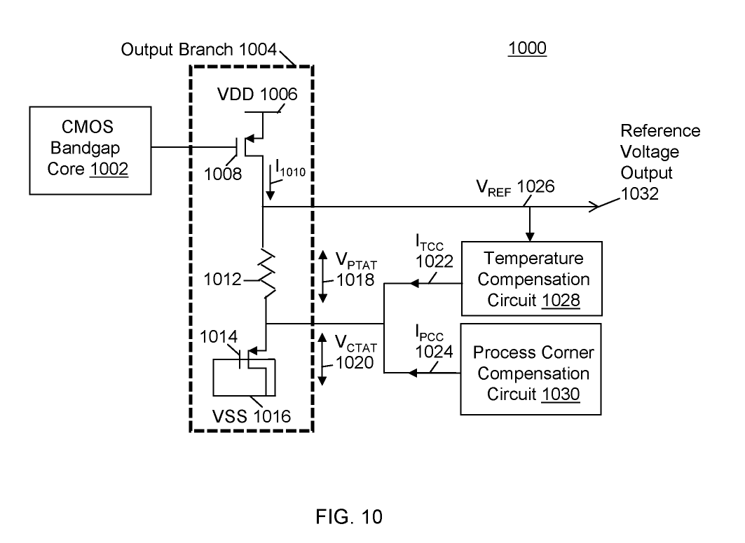

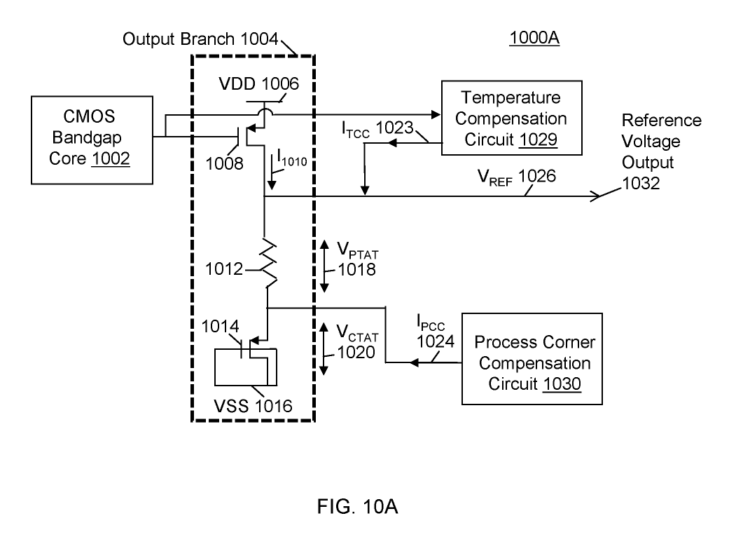

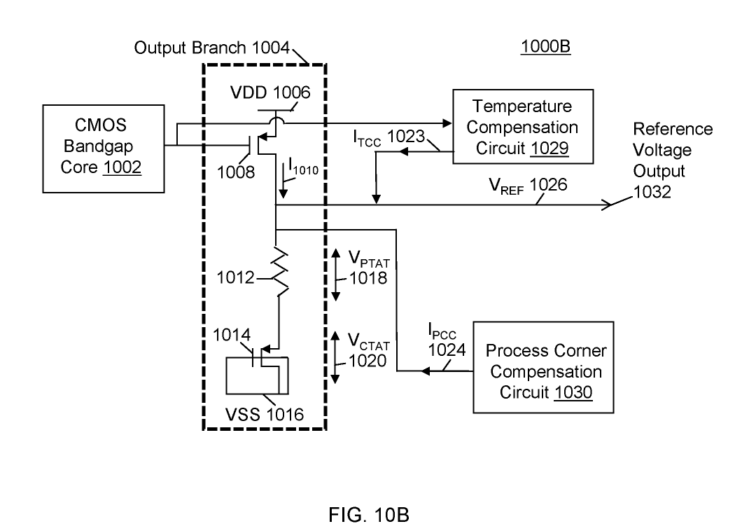

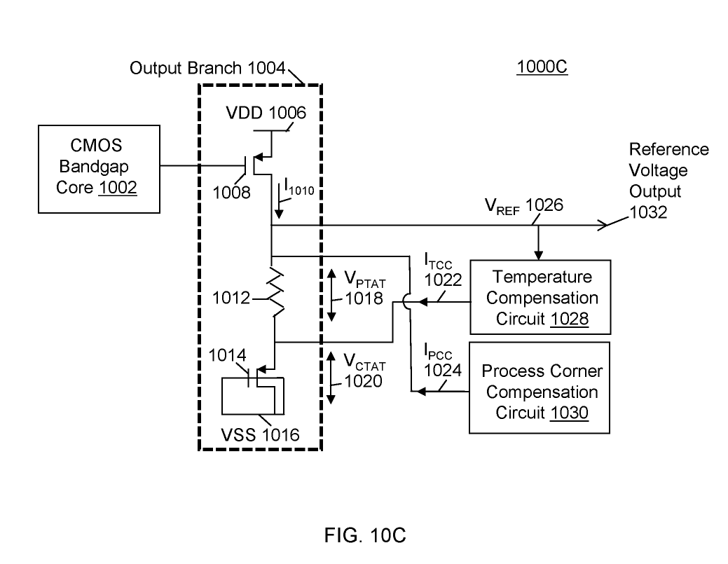

FIG. 10 is a schematic diagram of a bandgap or voltage reference circuit 1000 in accordance with various embodiments of the present disclosure. The voltage reference circuit 1000 can include, but is not limited to, a CMOS bandgap core circuit 1002, an output branch circuit 1004, a temperature compensation circuit 1028, and a process corner compensation circuit 1030. Note that the temperature compensation circuit 1028 and the process corner compensation circuit 1030 are each coupled to the output branch circuit 1004 to compensate the temperature and process variations of the voltage reference circuit 1000.

Specifically, the temperature compensation circuit 1028 and the process corner compensation circuit 1030 improve the overall accuracy of the voltage reference circuit 1000 by independently compensating the variation components (e.g., temperature and process corner) one at a time. More specifically, compensation of these variation components (e.g., temperature and process corner) can be done in the current domain using the compensation currents: a temperature compensation current (I_{TCC}) 1022 and a process corner compensation current (I_{PCC}) 1024, respectively. In addition, the voltage reference circuit 1000 can include a separate output branch 1004 to implement the summation of Voltage Complementary To Absolute Temperature (V_{CTAT}) 1020 and Voltage Proportional To Absolute Temperature (V_{PTAT}) 1018, which are utilized to produce a reference voltage 1026.

In an embodiment, the process corner compensation circuit 1030 can reduce process corner induced variation of the voltage reference circuit 1000. Furthermore, the temperature compensation circuit 1028 can reduce temperature induced variation of the voltage reference circuit 1000.

Within FIG. 10, in an embodiment, note that in order to compensate for process and temperature variations of the MOS transistors of the CMOS bandgap core circuit 1002 and the output branch 1004, the voltage reference circuit 1000 can include the temperature compensation circuit 1028 and the process corner compensation circuit 1030. The temperature compensation circuit 1028 and the process corner compensation circuit 1030 can all operate in the current domain. Specifically, the temperature compensation circuit 1028 and the process corner compensation circuit 1030 can each add current (e.g., I_{TCC} 1022 and I_{PCC} 1024, respectively) to the output branch 1004 at the node coupling a second terminal of the resistor 1012 and the source of the transistor 1014 to compensate for temperature and process corner. Note that current 1010 (I₁₀₁₀) is the main current of the output branch 1004 and the voltage reference circuit 1000. In various embodiments, the reference voltage 1026 can be bandgap based or based on something else.

In various embodiments, it is pointed out that the voltage reference circuit 1000 can be implemented in any application-specific integrated circuit (ASIC), system-on-chip (SoC), voltage regulator circuit, analog to digital (ADC) circuit, or any integrated circuit, but is not limited to such. In various embodiments, it is note that the voltage reference circuit 1000 is free of any bipolar junction transistors (BJTs).

Within FIG. 10, note that in various embodiments, the CMOS bandgap core circuit 1002, the temperature compensation circuit 1028, and the process corner compensation circuit 1030 can each be implemented in a wide variety of ways. For example, in various embodiments, the CMOS bandgap core circuit 200 of FIG. 2 can be utilized for implementing the CMOS bandgap core circuit 1002, but is not limited to such. Moreover, in various embodiments, the temperature compensation circuit 500 of FIG. 5 can be utilized for implementing the temperature compensation circuit 1028, but is not limited to such. In addition, the process corner compensation circuit 400 of FIG. 4 can be utilized for implementing the process corner compensation circuit 1030, but is not limited to such.

In an embodiment, the reference voltage circuit 1000 can include the CMOS bandgap core 1002, the output branch 1004, the temperature compensation circuit 1028, and the process corner compensation circuit 1030, but is not limited to such. Specifically, the output branch 1004 can be coupled with the CMOS bandgap core 1002, the temperature compensation circuit 1028, and the process corner compensation circuit 1030. Note that the gate of the transistor 1008 of the output branch 1004 can be coupled to the CMOS bandgap core 1002 and the source of the transistor 1008 can be coupled to VDD 1006. The drain of the transistor 1008 can be coupled to a first terminal of the resistor 1012, an input to the temperature compensation circuit 1028, and the reference voltage output 1032 of the reference voltage circuit 1000. In addition, the second terminal of the resistor 1012 can be coupled to the source of the transistor 1014 and the outputs of the temperature compensation circuit 1028 and the process corner compensation circuit 1030. It is pointed out that the gate, drain, and body of the transistor 1014 can be coupled to VSS (or ground) 1016.

Note that each of transistors 1008 and 1014 can be implemented in a wide variety of ways. In an embodiment, each of the transistors 1008 and 1014 can be implemented as, but is not limited to, a P-channel MOSFET which is also known as a PMOS. In addition, in an embodiment, each of the transistors 1008 and 1014 can be implemented as, but is not limited to, an N-channel MOSFET which is also known as an NMOS. The transistors 1008 and 1014 can be referred to as a current source and a diode, respectively. In an embodiment, a gate, a drain, and a source of the transistors 1008 and 1014 can each be referred to as a terminal of its transistor. Furthermore, in an embodiment, each gate of the transistors 1008 and 1014 can also be referred to as a control terminal of its transistor.

It is pointed out that the reference voltage circuit 1000 may not include all of the elements illustrated by FIG. 10. Additionally, the reference voltage circuit 1000 can be implemented to include one or more elements not illustrated by FIG. 10. It is noted that the reference voltage circuit 1000 can be utilized or implemented in any manner similar to that described and/or shown by the present disclosure, but is not limited to such.

FIG. 10A is a schematic diagram of a bandgap or voltage reference circuit 1000A in accordance with various embodiments of the present disclosure. It is pointed out that the voltage reference circuit 1000A illustrates that an output of its temperature compensation circuit (e.g., 1029) can be coupled to a different node of the output branch 1004 than that shown within the voltage reference circuit 1000 of FIG. 10. Note that the voltage reference circuit 1000A of FIG. 10A operates in a manner similar to the voltage reference circuit 1000 of FIG. 10. However, within the voltage reference circuit 1000A, the temperature compensation circuit 1029 adds current I_{TCC} 1029 to the output branch 1004 at the node coupling the drain of the transistor 1008, the first terminal of the resistor 1012, and the reference voltage output 1032 to compensates for temperature.

In an embodiment, an input of the temperature compensation circuit 1029 can be coupled to the output of the CMOS bandgap core 1002 and the gate of the transistor 1008. The output of the temperature compensation circuit 1029 can be coupled to the node coupling the drain of the transistor 1008, the first terminal of the resistor 1012, and the reference voltage output 1032. In various embodiments, the temperature compensation circuit 550 of FIG. 5A can be utilized for implementing the temperature compensation circuit 1029, but is not limited to such. In various embodiments, the remaining components of the voltage reference circuit 1000A can be coupled and implemented in any manner similar to that described and/or shown by the voltage reference circuit 1000 of FIG. 10, but are not limited to such.

Note that the reference voltage circuit 1000A may not include all of the elements illustrated by FIG. 10A. In addition, the reference voltage circuit 1000A can be implemented to include one or more elements not illustrated by FIG. 10A. It is noted that the reference voltage circuit 1000A can be utilized or implemented in any manner similar to that described and/or shown by the present disclosure, but is not limited to such.

FIG. 10B is a schematic diagram of a bandgap or voltage reference circuit 1000B in accordance with various embodiments of the present disclosure. Note that the voltage reference circuit 1000B illustrates that outputs of its temperature compensation circuit (e.g., 1029) and process corner compensation circuit (e.g., 1030) can be coupled to a different node of the output branch 1004 than that shown within the voltage reference circuit 1000 of FIG. 10. It is noted that the voltage reference circuit 1000B of FIG. 10B operates in a manner similar to the voltage reference circuit 1000 of FIG. 10. However, within the voltage reference circuit 1000B, the temperature compensation circuit 1029 and the process corner compensation circuit 1030 each add current (e.g., I_{TCC} 1023 and I_{PCC} 1024, respectively) to the output branch 1004 at the node coupling the drain of the transistor 1008, the first terminal of the resistor 1012, and the reference voltage output 1032 to compensates for temperature and process corner.

In an embodiment, the output of the process corner compensation circuit 1030 can be coupled to the node coupling the drain of the transistor 1008, the first terminal of the resistor 1012, and the reference voltage output 1032. Furthermore, an input of the temperature compensation circuit 1029 can be coupled to the output of the CMOS bandgap core 1002 and the gate of the transistor 1008. The output of the temperature compensation circuit 1029 can be coupled to the node coupling the drain of the transistor 1008, the first terminal of the resistor 1012, and the reference voltage output 1032. In various embodiments, the temperature compensation circuit 550 of FIG. 5A can be utilized for implementing the temperature compensation circuit 1029, but is not limited to such. In various embodiments, the remaining components of the voltage reference circuit 1000B can be coupled and implemented in any manner similar to that described and/or shown by the voltage reference circuit 1000 of FIG. 10, but are not limited to such.

It is pointed out that the reference voltage circuit 1000B may not include all of the elements illustrated by FIG. 10B. Additionally, the reference voltage circuit 1000B can be implemented to include one or more elements not illustrated by FIG. 10B. Note that the reference voltage circuit 1000B can be utilized or implemented in any manner similar to that described and/or shown by the present disclosure, but is not limited to such.

FIG. 10C is a schematic diagram of a bandgap or voltage reference circuit 1000C in accordance with various embodiments of the present disclosure. It is noted that the voltage reference circuit 1000C illustrates that the output of its process corner compensation circuit (e.g., 1030) can be coupled to a different node of the output branch 1004 than that shown within the voltage reference circuit 1000 of FIG. 10. Note that the voltage reference circuit 1000C of FIG. 10C operates in a manner similar to the voltage reference circuit 1000 of FIG. 10. However, within the voltage reference circuit 1000C, the process corner compensation circuit 1030 adds current I_{PCC} 1024 to the output branch 1004 at the node coupling the drain of the transistor 1008, the first terminal of the resistor 1012, and the reference voltage output 1032 to compensates for process corner.

In an embodiment, the output of the process corner compensation circuit 1030 can be coupled to the node coupling the drain of the transistor 1008, the first terminal of the resistor 1012, and the reference voltage output 1032. In various embodiments, the remaining components of the voltage reference circuit 1000C can be coupled and implemented in any manner similar to that described and/or shown by the voltage reference circuit 1000 of FIG. 10, but are not limited to such.

It is pointed out that the reference voltage circuit 1000C may not include all of the elements illustrated by FIG. 10C. Additionally, the reference voltage circuit 1000C can be implemented to include one or more elements not illustrated by FIG. 10C. It is noted that the reference voltage circuit 1000C can be utilized or implemented in any manner similar to that described and/or shown by the present disclosure, but is not limited to such.

As shown within FIGS. 10, 10A, 10B, and 10C, the outputs of a temperature compensation circuit (e.g., 1028 or 1029) and a process corner compensation circuit (e.g., 1030) of a voltage reference circuit in accordance with an embodiment of the present disclosure can be coupled to the output branch 1004 anywhere between the drain of the transistor 1008 and the source of the transistor 1014.

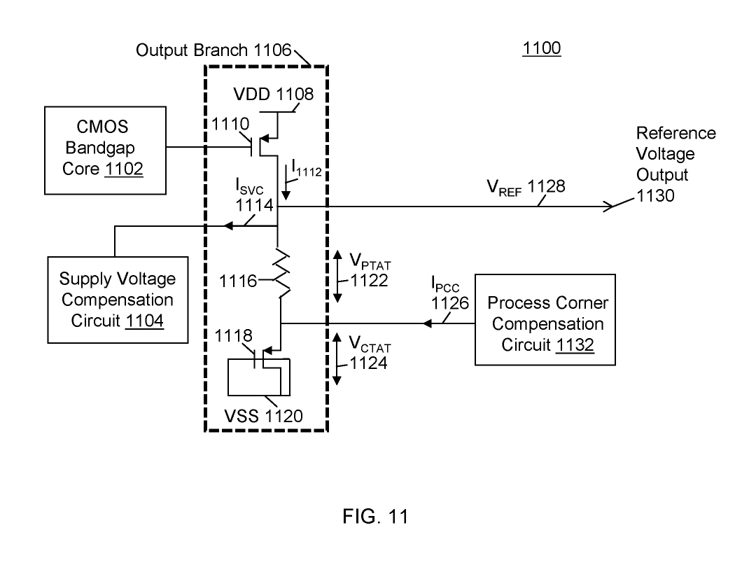

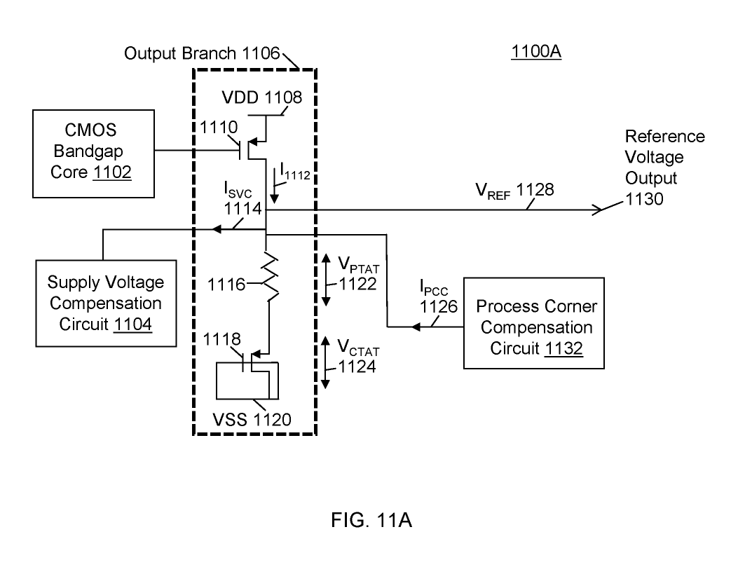

FIG. 11 is a schematic diagram of a bandgap or voltage reference circuit 1100 in accordance with various embodiments of the present disclosure. The voltage reference circuit 1100 can include, but is not limited to, a CMOS bandgap core circuit 1102, a supply voltage compensation circuit 1104, an output branch circuit 1106, and a process corner compensation circuit 1132. It is noted that the supply voltage compensation circuit 1104 and the process corner compensation circuit 1132 are each coupled to the output branch circuit 1106 to compensate the supply voltage and process variations of the voltage reference circuit 1100.

Specifically, the supply voltage compensation circuit 1104 and the process corner compensation circuit 1132 improve the overall accuracy of the voltage reference circuit 1100 by independently compensating the variation components (e.g., supply voltage and process corner) one at a time. More specifically, compensation of these variation components (e.g., supply voltage and process corner) can be done in the current domain using the compensation currents: a supply voltage compensation current (I_{SVC}) 1114 and a process corner compensation current (I_{PCC}) 1026, respectively. Furthermore, the voltage reference circuit 1100 can include a separate output branch 1106 to implement the summation of Voltage Complementary To Absolute Temperature (V_{CTAT}) 1124 and Voltage Proportional To Absolute Temperature (V_{PTAT}) 1122, which are utilized to produce a reference voltage 1128.

In an embodiment, it is noted that the supply voltage compensation circuit 1104 can reduce supply voltage induced variation of the voltage reference circuit 1100. In addition, the process corner compensation circuit 1132 can reduce process corner induced variation of the voltage reference circuit 1100.

Within FIG. 11, in an embodiment, note that in order to compensate for process and supply voltage variations of the MOS transistors of the CMOS bandgap core circuit 1102 and the output branch 1106, the voltage reference circuit 1100 can include the supply voltage compensation circuit 1104 and the process corner compensation circuit 1132. The supply voltage compensation circuit 1104 and the process corner compensation circuit 1132 can all operate in the current domain. Specifically, the supply voltage compensation circuit 1104 can subtract out some current (e.g., I_{SVC} 1114) from a node of the output branch 1106 coupling the drain of the transistor 1110, a first terminal of the resistor 1116, and the reference voltage output 132 to compensate for variation in supply voltage 1108. The process corner compensation circuit 1132 can add current (e.g., I_{PCC} 1126) to the output branch 1106 at the node coupling a second terminal of the resistor 1116 and the source of the transistor 1118 to compensate for process corner. It is noted that current 1112 (I₁₁₁₂) is the main current of the output branch 1106 and the voltage reference circuit 1100. In various embodiments, the reference voltage 1128 can be bandgap based or based on something else.

In various embodiments, the voltage reference circuit 1100 can be implemented in any application-specific integrated circuit (ASIC), system-on-chip (SoC), voltage regulator circuit, analog to digital (ADC) circuit, or any integrated circuit, but is not limited to such. In various embodiments, note that the voltage reference circuit 1100 is free of any bipolar junction transistors (BJTs).

Within FIG. 11, note that in various embodiments, the CMOS bandgap core circuit 1102, the supply voltage compensation circuit 1104, and the process corner compensation circuit 1132 can each be implemented in a wide variety of ways. For example, in various embodiments, the CMOS bandgap core circuit 200 of FIG. 2 can be utilized for implementing the CMOS bandgap core circuit 1102, but is not limited to such. Additionally, in various embodiments, the supply voltage compensation circuit 300 of FIG. 3 can be utilized for implementing the supply voltage compensation circuit 1104, but is not limited to such. Moreover, the process corner compensation circuit 400 of FIG. 4 can be utilized for implementing the process corner compensation circuit 1132, but is not limited to such.

In an embodiment, the reference voltage circuit 1100 can include the CMOS bandgap core 1102, the supply voltage compensation circuit 1104, the output branch 1106, and the process corner compensation circuit 1132, but is not limited to such. Specifically, the output branch 1106 can be coupled with the CMOS bandgap core 1102, the supply voltage compensation circuit 1104, and the process corner compensation circuit 1132. Note that the gate of the transistor 1110 of the output branch 1106 can be coupled to the CMOS bandgap core 1102 and the source of the transistor 1110 can be coupled to VDD 1108. The drain of the transistor 1110 can be coupled to a first terminal of the resistor 1116, an input to the supply voltage compensation circuit 1104, and the reference voltage output 1130 of the reference voltage circuit 1100. Furthermore, the second terminal of the resistor 1116 can be coupled to the source of the transistor 1118 and the output of the process corner compensation circuit 1132. Note that the gate, drain, and body of the transistor 1118 can be coupled to VSS (or ground) 1120.

It is noted that each of transistors 1110 and 1118 can be implemented in a wide variety of ways. In an embodiment, each of the transistors 1110 and 1118 can be implemented as, but is not limited to, a P-channel MOSFET which is also known as a PMOS. Furthermore, in an embodiment, each of the transistors 1110 and 1118 can be implemented as, but is not limited to, an N-channel MOSFET which is also known as an NMOS. The transistors 1110 and 1118 can be referred to as a current source and a diode, respectively. In an embodiment, note that a gate, a drain, and a source of the transistors 1110 and 1118 can each be referred to as a terminal of its transistor. In addition, in an embodiment, each gate of the transistors 1110 and 1118 can also be referred to as a control terminal of its transistor.

It is pointed out that the reference voltage circuit 1100 may not include all of the elements illustrated by FIG. 11. Furthermore, the reference voltage circuit 1100 can be implemented to include one or more elements not illustrated by FIG. 11. Note that the reference voltage circuit 1100 can be utilized or implemented in any manner similar to that described and/or shown by the present disclosure, but is not limited to such.

FIG. 11A is a schematic diagram of a bandgap or voltage reference circuit 1100A in accordance with various embodiments of the present disclosure. It is noted that the voltage reference circuit 1100A illustrates that the output of its process corner compensation circuit (e.g., 1132) can be coupled to a different node of the output branch 1106 than that shown within the voltage reference circuit 1100 of FIG. 11. Note that the voltage reference circuit 1100A of FIG. 11A operates in a manner similar to the voltage reference circuit 1100 of FIG. 11. However, within the voltage reference circuit 1100A, the process corner compensation circuit 1132 adds current I_{PCC} 1126 to the output branch 1106 at the node coupling the drain of the transistor 1110, the first terminal of the resistor 1116, the reference voltage output 1130, and the input to the supply voltage compensation circuit 1104 to compensates for process corner.

In an embodiment, the output of the process corner compensation circuit 1132 can be coupled to the node coupling the drain of the transistor 1108, the first terminal of the resistor 1116, the reference voltage output 1130, and the input to the supply voltage compensation circuit 1104. In various embodiments, the remaining components of the voltage reference circuit 1100A can be coupled and implemented in any manner similar to that described and/or shown by the voltage reference circuit 1100 of FIG. 11, but are not limited to such.

Note that the reference voltage circuit 1100A may not include all of the elements illustrated by FIG. 11A. Furthermore, the reference voltage circuit 1100A can be implemented to include one or more elements not illustrated by FIG. 11A. It is noted that the reference voltage circuit 1100A can be utilized or implemented in any manner similar to that described and/or shown by the present disclosure, but is not limited to such.

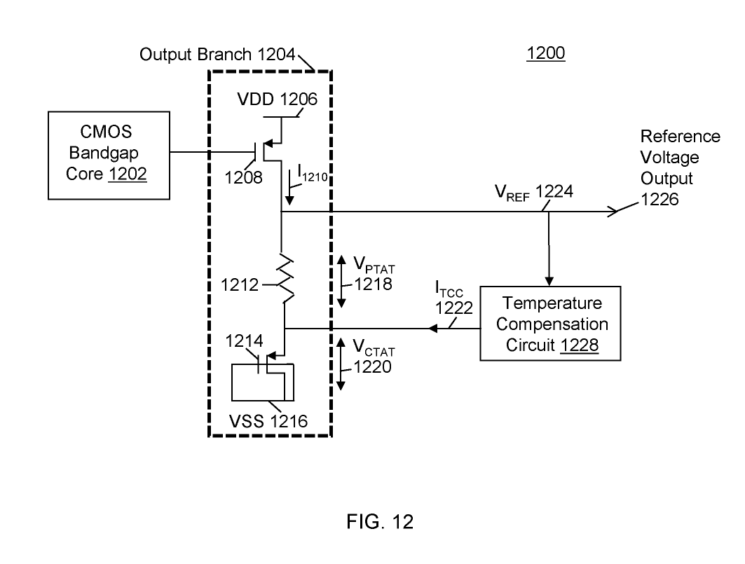

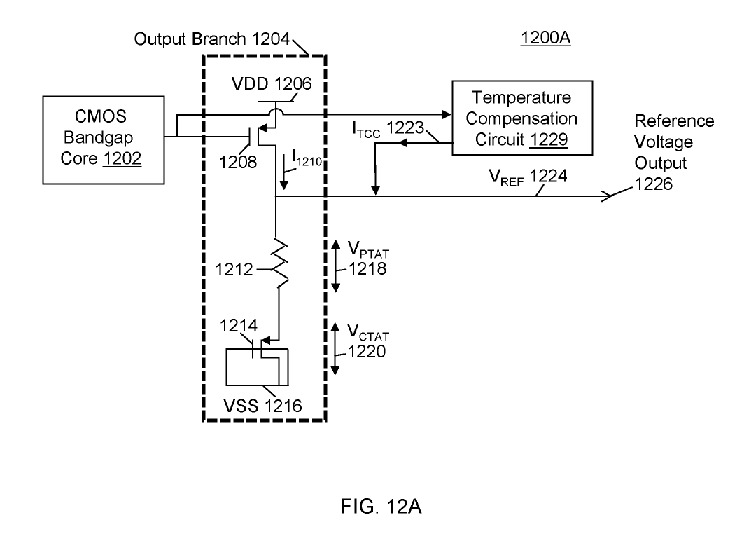

FIG. 12 is a schematic diagram of a bandgap or voltage reference circuit 1200 in accordance with various embodiments of the present disclosure. The voltage reference circuit 1200 can include, but is not limited to, a CMOS bandgap core circuit 1202, an output branch circuit 1204, and a temperature compensation circuit 1228. Note that the temperature compensation circuit 1228 is coupled to the output branch circuit 1204 to compensate the temperature variations of the voltage reference circuit 1200. It is pointed out that one benefit of the voltage reference circuit 1200 is its reduced size which results in reducing the cost of fabricating it.

Specifically, the temperature compensation circuit 1228 improves the overall accuracy of the voltage reference circuit 1200 by independently compensating for the temperature. More specifically, compensation of the temperature can be done in the current domain using a temperature compensation current (I_{TCC}) 1222 produced by the temperature compensation circuit 1228. In an embodiment, it is noted that the temperature compensation circuit 1228 can reduce temperature induced variation of the voltage reference circuit 1200. It is noted that the voltage reference circuit 1200 can include a separate output branch 1204 to implement the summation of Voltage Complementary To Absolute Temperature (V_{CTAT}) 1220 and Voltage Proportional To Absolute Temperature (V_{PTAT}) 1218, which are utilized to produce a reference voltage 1224.

Within FIG. 12, in an embodiment, note that in order to compensate for temperature variations of the MOS transistors of the CMOS bandgap core circuit 1202 and the output branch 1204, the voltage reference circuit 1200 can include the temperature compensation circuit 1228. As previously noted, the temperature compensation circuit 1228 can operate in the current domain. Specifically, the temperature compensation circuit 1228 adds current (e.g., I_{TCC} 1222) to the output branch 1204 at the node coupling a second terminal of the resistor 1212 and the source of the transistor 1214 to compensate for temperature. It is noted that current 1210 (I₁₂₁₀) is the main current of the output branch 1204 and the voltage reference circuit 1200. The reference voltage 1224 is output from the voltage reference circuit 1200 via the reference voltage output 1226. In various embodiments, the reference voltage 1224 can be bandgap based or based on something else.

In various embodiments, it is pointed out that the voltage reference circuit 1200 can be implemented in any application-specific integrated circuit (ASIC), system-on-chip (SoC), voltage regulator circuit, analog to digital (ADC) circuit, or any integrated circuit, but is not limited to such. In various embodiments, it is note that the voltage reference circuit 1200 is free of any bipolar junction transistors (BJTs).

Within FIG. 12, note that in various embodiments, the CMOS bandgap core circuit 1202 and the temperature compensation circuit 1228 can each be implemented in a wide variety of ways. For example, in various embodiments, the CMOS bandgap core circuit 200 of FIG. 2 can be utilized for implementing the CMOS bandgap core circuit 1202, but is not limited to such. Furthermore, in various embodiments, the temperature compensation circuit 500 of FIG. 5 can be utilized for implementing the temperature compensation circuit 1228, but is not limited to such.

In an embodiment, the reference voltage circuit 1200 can include the CMOS bandgap core 1202, the output branch 1204, and the temperature compensation circuit 1228, but is not limited to such. Specifically, the output branch 1204 can be coupled with the CMOS bandgap core 1202 and the temperature compensation circuit 1228. The gate of the transistor 1208 of the output branch 1204 can be coupled to the CMOS bandgap core 1202 and the source of the transistor 1208 can be coupled to VDD 1206. The drain of the transistor 1208 can be coupled to a first terminal of the resistor 1212, an input to the temperature compensation circuit 1228, and the reference voltage output 1226 of the reference voltage circuit 1200. Additionally, a second terminal of the resistor 1212 can be coupled to the source of the transistor 1214 and the output of the temperature compensation circuit 1228. Note that the gate, drain, and body of the transistor 1214 can be coupled to VSS (or ground) 1216.

Within FIG. 12, note that each of transistors 1208 and 1214 can be implemented in a wide variety of ways. In an embodiment, each of the transistors 1208 and 1214 can be implemented as, but is not limited to, a P-channel MOSFET which is also known as a PMOS. In an embodiment, each of the transistors 1208 and 1214 can be implemented as, but is not limited to, an N-channel MOSFET which is also known as an NMOS. The transistors 1208 and 1214 can be referred to as a current source and a diode, respectively. In an embodiment, note that a gate, a drain, and a source of the transistors 1208 and 1214 can each be referred to as a terminal of its transistor. In an embodiment, each gate of the transistors 1208 and 1214 can also be referred to as a control terminal of its transistor.

Note that the reference voltage circuit 1200 may not include all of the elements illustrated by FIG. 12. In addition, the reference voltage circuit 1200 can be implemented to include one or more elements not illustrated by FIG. 12. It is pointed out that the reference voltage circuit 1200 can be utilized or implemented in any manner similar to that described and/or shown by the present disclosure, but is not limited to such.

FIG. 12A is a schematic diagram of a bandgap or voltage reference circuit 1200A in accordance with various embodiments of the present disclosure. Note that the voltage reference circuit 1200A illustrates that an output of its temperature compensation circuit (e.g., 1229) can be coupled to a different node of the output branch 1204 than that shown within the voltage reference circuit 1200 of FIG. 12. It is noted that the voltage reference circuit 1200A of FIG. 12A operates in a manner similar to the voltage reference circuit 1200 of FIG. 12. However, within the voltage reference circuit 1200A, the temperature compensation circuit 1229 adds current (e.g., I_{TCC} 1223) to the output branch 1204 at the node coupling the drain of the transistor 1208, the first terminal of the resistor 1212, and the reference voltage output 1226 to compensate for temperature.

In an embodiment, an input of the temperature compensation circuit 1229 can be coupled to the output of the CMOS bandgap core 1202 and the gate of the transistor 1208. The output of the temperature compensation circuit 1229 can be coupled to the node coupling the drain of the transistor 1208, the first terminal of the resistor 1212, and the reference voltage output 1226. In various embodiments, the temperature compensation circuit 550 of FIG. 5A can be utilized for implementing the temperature compensation circuit 1229, but is not limited to such. In various embodiments, the remaining components of the voltage reference circuit 1200A can be coupled and implemented in any manner similar to that described and/or shown by the voltage reference circuit 1200 of FIG. 12, but are not limited to such.

It is pointed out that the reference voltage circuit 1200A may not include all of the elements illustrated by FIG. 12A. In addition, the reference voltage circuit 1200A can be implemented to include one or more elements not illustrated by FIG. 12A. Note that the reference voltage circuit 1200A can be utilized or implemented in any manner similar to that described and/or shown by the present disclosure, but is not limited to such.

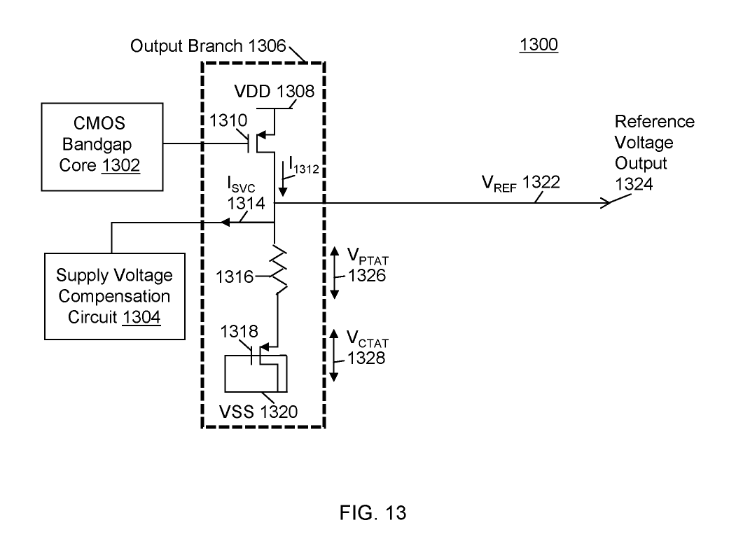

FIG. 13 is a schematic diagram of a bandgap or voltage reference circuit 1300 in accordance with various embodiments of the present disclosure. The voltage reference circuit 1300 can include, but is not limited to, a CMOS bandgap core circuit 1302, a supply voltage compensation circuit 1304, and an output branch circuit 1306. It is noted that the supply voltage compensation circuit 1304 is coupled to the output branch circuit 1306 to compensate the supply voltage variations of the voltage reference circuit 1300.

Specifically, the supply voltage compensation circuit 1304 improves the overall accuracy of the voltage reference circuit 1300 by independently compensating the variation component (e.g., supply voltage). Compensation of this variation component (e.g., supply voltage) can be done in the current domain using a supply voltage compensation current (I_{SVC}) 1314. In addition, the voltage reference circuit 1300 can include a separate output branch 1306 to implement the summation of Voltage Complementary To Absolute Temperature (V_{CTAT}) 1328 and Voltage Proportional To Absolute Temperature (V_{PTAT}) 1326, which are utilized to produce a reference voltage 1322. In an embodiment, note that the supply voltage compensation circuit 1304 can reduce supply voltage induced variation of the voltage reference circuit 1300.

Within FIG. 13, in an embodiment, note that in order to compensate for supply voltage variations of the MOS transistors of the CMOS bandgap core circuit 1302 and the output branch 1306, the voltage reference circuit 1300 can include the supply voltage compensation circuit 1304. The supply voltage compensation circuit 1304 can operate in the current domain. Specifically, the supply voltage compensation circuit 1304 can subtract out some current (e.g., I_{SVC} 1314) from a node of the output branch 1306 coupling the drain of the transistor 1310, a first terminal of the resistor 1316, and the reference voltage output 1324 to compensate for variation in supply voltage 1308. It is noted that current 1312 (I₁₃₁₂) is the main current of the output branch 1306 and the voltage reference circuit 1300. In various embodiments, the reference voltage 1328 can be bandgap based or based on something else.

In various embodiments, the voltage reference circuit 1300 can be implemented in any application-specific integrated circuit (ASIC), system-on-chip (SoC), voltage regulator circuit, analog to digital (ADC) circuit, or any integrated circuit, but is not limited to such. In various embodiments, note that the voltage reference circuit 1300 is free of any bipolar junction transistors (BJTs).

Within FIG. 13, it is noted that in various embodiments, the CMOS bandgap core circuit 1302 and the supply voltage compensation circuit 1304 can each be implemented in a wide variety of ways. For example, in various embodiments, the CMOS bandgap core circuit 200 of FIG. 2 can be utilized for implementing the CMOS bandgap core circuit 1302, but is not limited to such. Moreover, in various embodiments, the supply voltage compensation circuit 300 of FIG. 3 can be utilized for implementing the supply voltage compensation circuit 1304, but is not limited to such.

In an embodiment, the reference voltage circuit 1300 can include the CMOS bandgap core 1302, the supply voltage compensation circuit 1304, and the output branch 1306, but is not limited to such. Specifically, the output branch 1306 can be coupled with the CMOS bandgap core 1302 and the supply voltage compensation circuit 1304. Note that the gate of the transistor 1310 of the output branch 1306 can be coupled to the CMOS bandgap core 1302 and the source of the transistor 1310 can be coupled to VDD 1308. The drain of the transistor 1310 can be coupled to a first terminal of the resistor 1316, an input to the supply voltage compensation circuit 1304, and the reference voltage output 1330 of the reference voltage circuit 1300. Furthermore, the second terminal of the resistor 1316 can be coupled to the source of the transistor 1318. It is noted that the gate, drain, and body of the transistor 1318 can be coupled to VSS (or ground) 1320.

Within FIG. 13, note that each of transistors 1310 and 1318 can be implemented in a wide variety of ways. In an embodiment, each of the transistors 1310 and 1318 can be implemented as, but is not limited to, a P-channel MOSFET which is also known as a PMOS. In addition, in an embodiment, each of the transistors 1310 and 1318 can be implemented as, but is not limited to, an N-channel MOSFET which is also known as an NMOS. The transistors 1310 and 1318 can be referred to as a current source and a diode, respectively. In an embodiment, note that a gate, a drain, and a source of the transistors 1310 and 1318 can each be referred to as a terminal of its transistor. Furthermore, in an embodiment, each gate of the transistors 1310 and 1318 can also be referred to as a control terminal of its transistor.

It is pointed out that the reference voltage circuit 1300 may not include all of the elements illustrated by FIG. 13. Additionally, the reference voltage circuit 1300 can be implemented to include one or more elements not illustrated by FIG. 13. Note that the reference voltage circuit 1300 can be utilized or implemented in any manner similar to that described and/or shown by the present disclosure, but is not limited to such.

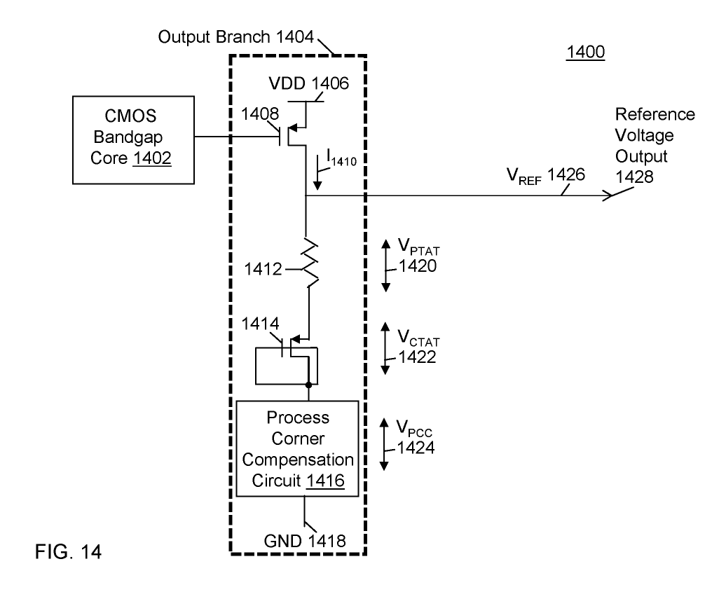

FIG. 14 is a schematic diagram of a bandgap or voltage reference circuit 1400 in accordance with various embodiments of the present disclosure. It is pointed out that the bandgap or voltage reference circuit 1400 is based on voltage domain compensation for the process corner variation. Note that a process corner compensation circuit 1416 of the voltage reference circuit 1400 can be implemented at the bottom of an output branch 1404 so that the voltage domain summation can be achieved by adding appropriate programmable voltage depending on the process corner. In an embodiment, note that the reference voltage circuit 1400 is free of any bipolar junction transistors (BJTs).

Within the reference voltage circuit 1400, the process corner compensation circuit 1416 adds voltage (V_{PCC}) 1424 at the bottom of the output branch 1404. It is noted that the amount of additional voltage 1424 that is added by the process corner compensation circuit 1416 depends upon the process corner. In addition, the separate output branch 1404 can be utilized to implement the summation of Voltage Complementary To Absolute Temperature (V_{CTAT}) 1422 and Voltage Proportional To Absolute Temperature (V_{PTAT}) 1420 with the voltage (V_{PCC}) 1424 of the process corner compensation circuit 1416, which are utilized to produce a reference voltage 1426.

In various embodiments, note that the reference voltage circuit 1400 consumes less power than the reference voltage circuit 900 of FIG. 9. Specifically, in an embodiment, the reference voltage circuit 900 creates more current resulting in more power consumption. Conversely, the reference voltage circuit 1400 does not consume any more current because it uses the current 1410 of the output branch 1404 to develop the voltage 1424 of the process corner compensation circuit 1416. However, in various embodiments, the reference voltage circuit 900 can utilize a lower supply voltage (VDD) and can result in a smaller size than the reference voltage circuit 1400.

Within FIG. 14, note that in various embodiments, the CMOS bandgap core circuit 1402 can be implemented in a wide variety of ways. For example, in various embodiments, the CMOS bandgap core circuit 200 of FIG. 2 can be utilized for implementing the CMOS bandgap core circuit 1402, but is not limited to such.

In various embodiments, it is pointed out that the voltage reference circuit 1400 can be implemented in any application-specific integrated circuit (ASIC), system-on-chip (SoC), voltage regulator circuit, analog to digital (ADC) circuit, or any integrated circuit, but is not limited to such.

Within FIG. 14, in an embodiment, the reference voltage circuit 1400 can include the CMOS bandgap core 1402, the output branch 1404, and the process corner compensation circuit 1416, but is not limited to such. Note that the output branch 1404 can be implemented to include the process corner compensation circuit 1416. The output branch 1404 can be coupled with the CMOS bandgap core 1402. It is pointed out that the gate of the transistor 1408 of the output branch 1404 can be coupled to the CMOS bandgap core 1402 and the source of the transistor 610 can be coupled to VDD 1406. In addition, the drain of the transistor 1408 can be coupled to a first terminal of the resistor 1412 and the reference voltage output 1432 of the reference voltage circuit 1400. Furthermore, a second terminal of the resistor 1412 can be coupled to the source of the transistor 1414. The gate, drain, and body of the transistor 1414 can be coupled to the process corner compensation circuit 1416. The process corner compensation circuit 1416 can be coupled to ground 1418.

Within FIG. 14, note that each of transistors 1408 and 1414 can be implemented in a wide variety of ways. In an embodiment, each of the transistors 1408 and 1414 can be implemented as, but is not limited to, a P-channel MOSFET which is also known as a PMOS. Moreover, in an embodiment, each of the transistors 1408 and 1414 can be implemented as, but is not limited to, an N-channel MOSFET which is also known as an NMOS. It is pointed out that each of the transistors 1408 and 1414 can be referred to as a switching element. In an embodiment, note that a gate, a drain, and a source of the transistors 1408 and 1414 can each be referred to as a terminal of its transistor. Additionally, in an embodiment, each gate of the transistors 1408 and 1414 can also be referred to as a control terminal of its transistor.

Note that the reference voltage circuit 1400 may not include all of the elements illustrated by FIG. 14. Moreover, the reference voltage circuit 1400 can be implemented to include one or more elements not illustrated by FIG. 14. It is pointed out that the reference voltage circuit 1400 can be utilized or implemented in any manner similar to that described and/or shown by the present disclosure, but is not limited to such.

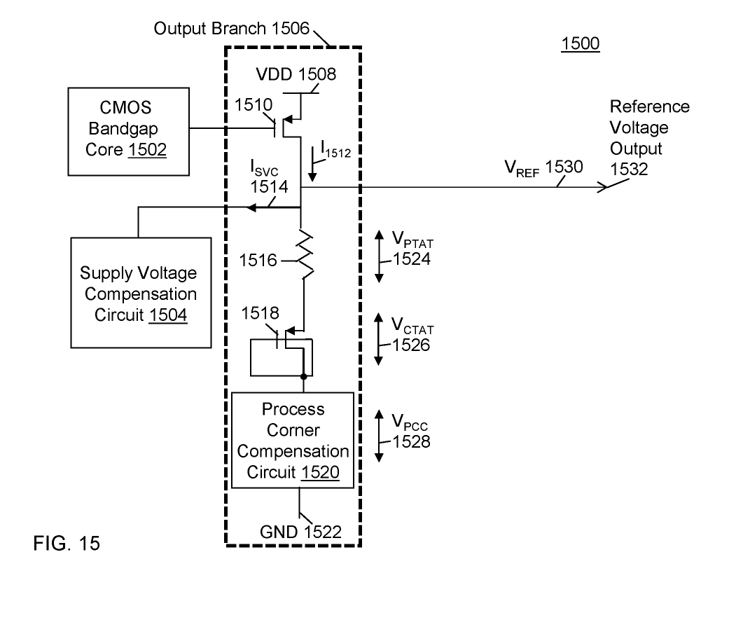

FIG. 15 is a schematic diagram of a bandgap or voltage reference circuit 1500 in accordance with various embodiments of the present disclosure. Note that the bandgap or voltage reference circuit 1500 is based on voltage domain compensation for the process corner variation. Unlike the voltage reference circuit 100 of FIG. 1, a process corner compensation circuit 1520 of the voltage reference circuit 1500 can be implemented at the bottom of an output branch 1506 so that the voltage domain summation can be achieved by adding appropriate programmable voltage depending on the process corner. In an embodiment, note that the reference voltage circuit 1500 is free of any bipolar junction transistors (BJTs).

Within the reference voltage circuit 1500, the process corner compensation circuit 1520 adds voltage (V_{PCC}) 1528 at the bottom of the output branch 1506. Note that the amount of additional voltage 1528 that is added by the process corner compensation circuit 1520 depends upon the process corner. In addition, the separate output branch 1506 can be utilized to implement the summation of Voltage Complementary To Absolute Temperature (V_{CTAT}) 1526 and Voltage Proportional To Absolute Temperature (V_{PTAT}) 1524 with the voltage (V_{PCC}) 1528 of the process corner compensation circuit 1520, which are utilized to produce a reference voltage 1530.

Within FIG. 15, note that the supply voltage compensation circuit 1504 and the process corner compensation circuit 1520 improve the overall accuracy of the voltage reference circuit 1500 by independently compensating the variation components (e.g., supply voltage and process corner) one at a time. It is noted that the supply voltage compensation circuit 1504 can operate in the current domain. Specifically, the supply voltage compensation circuit 1504 can subtract out some current (e.g., I_{SVC} 1514) from a node of the output branch 1506 coupling the drain of the transistor 1510, a first terminal of the resistor 1516, and the reference voltage output 1532 to compensate for variation in supply voltage 1508. It is pointed out that current 1512 (I₁₅₁₂) is the main current of the output branch 1506 and the voltage reference circuit 1500. In various embodiments, the reference voltage 1530 can be bandgap based or based on something else.

In various embodiments, the reference voltage circuit 1500 consumes less power than the reference voltage circuit 1100 of FIG. 11. Specifically, in an embodiment, the reference voltage circuit 1100 creates more current resulting in more power consumption. Conversely, the reference voltage circuit 1500 does not consume any more current because it uses the current 1512 of the output branch 1506 to develop the voltage 1528 of the process corner compensation circuit 1520. However, in various embodiments, the reference voltage circuit 1100 can utilize a lower supply voltage (VDD) and can result in a smaller size than the reference voltage circuit 1500.

Within FIG. 15, in various embodiments, the CMOS bandgap core circuit 1502 and the supply voltage compensation circuit 1504 can each be implemented in a wide variety of ways. For example, in various embodiments, the CMOS bandgap core circuit 200 of FIG. 2 can be utilized for implementing the CMOS bandgap core circuit 1502, but is not limited to such. Additionally, in various embodiments, the supply voltage compensation circuit 300 of FIG. 3 can be utilized for implementing the supply voltage compensation circuit 1504, but is not limited to such.

In various embodiments, it is pointed out that the voltage reference circuit 1500 can be implemented in any application-specific integrated circuit (ASIC), system-on-chip (SoC), voltage regulator circuit, analog to digital (ADC) circuit, or any integrated circuit, but is not limited to such.

Within FIG. 15, in an embodiment, the reference voltage circuit 1500 can include the CMOS bandgap core 1502, the supply voltage compensation circuit 1504, the output branch 1506, and the process corner compensation circuit 1520, but is not limited to such. Note that the output branch 1506 can be implemented to include the process corner compensation circuit 1520. The output branch 1506 can be coupled with the CMOS bandgap core 1502 and the supply voltage compensation circuit 1504. It is pointed out that the gate of the transistor 1510 of the output branch 1506 can be coupled to the CMOS bandgap core 1502 and the source of the transistor 1510 can be coupled to VDD 1508. In addition, the drain of the transistor 1510 can be coupled to the supply voltage compensation circuit 1504, a first terminal of the resistor 1516, and the reference voltage output 1532 of the reference voltage circuit 1500. Moreover, a second terminal of the resistor 1516 can be coupled to the source of the transistor 1518. The gate, drain, and body of the transistor 1518 can be coupled to the process corner compensation circuit 1520. The process corner compensation circuit 1520 can be coupled to ground 1522.

Within FIG. 15, it is noted that each of transistors 1510 and 1518 can be implemented in a wide variety of ways. In an embodiment, each of the transistors 1510 and 1518 can be implemented as, but is not limited to, a P-channel MOSFET which is also known as a PMOS. Moreover, in an embodiment, each of the transistors 1510 and 1518 can be implemented as, but is not limited to, an N-channel MOSFET which is also known as an NMOS. Note that each of the transistors 1510 and 1518 can be referred to as a switching element. In an embodiment, note that a gate, a drain, and a source of the transistors 1510 and 1518 can each be referred to as a terminal of its transistor. Furthermore, in an embodiment, each gate of the transistors 1510 and 1518 can also be referred to as a control terminal of its transistor.

It is pointed out that the reference voltage circuit 1500 may not include all of the elements illustrated by FIG. 15. Additionally, the reference voltage circuit 1500 can be implemented to include one or more elements not illustrated by FIG. 15. Note that the reference voltage circuit 1500 can be utilized or implemented in any manner similar to that described and/or shown by the present disclosure, but is not limited to such.

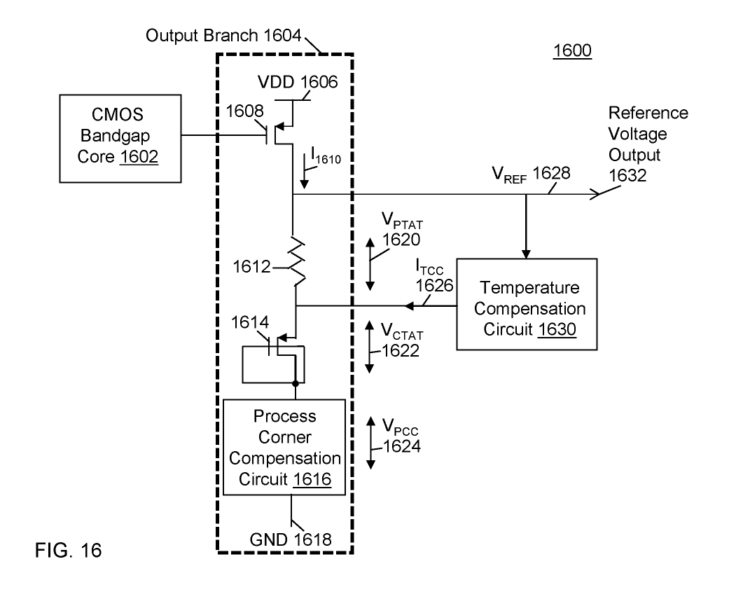

FIG. 16 is a schematic diagram of a bandgap or voltage reference circuit 1600 in accordance with various embodiments of the present disclosure. It is noted that the bandgap or voltage reference circuit 1600 is based on voltage domain compensation for the process corner variation. It is pointed out that a process corner compensation circuit 1620 of the voltage reference circuit 1600 can be implemented at the bottom of an output branch 1604 so that the voltage domain summation can be achieved by adding appropriate programmable voltage depending on the process corner. In an embodiment, note that the reference voltage circuit 1600 is free of any bipolar junction transistors (BJTs).

Within the reference voltage circuit 1600, the process corner compensation circuit 1616 adds voltage (V_{PCC}) 1624 at the bottom of the output branch 1604. Note that the amount of additional voltage 1624 that is added by the process corner compensation circuit 1616 depends upon the process corner. Furthermore, the separate output branch 1604 can be utilized to implement the summation of Voltage Complementary To Absolute Temperature (V_{CTAT}) 1622 and Voltage Proportional To Absolute Temperature (V_{PTAT}) 1620 with the voltage (V_{PCC}) 1624 of the process corner compensation circuit 1616, which are utilized to produce a reference voltage 1628.

Within FIG. 16, it is noted that the temperature compensation circuit 1630 and the process corner compensation circuit 1616 improve the overall accuracy of the voltage reference circuit 1600 by independently compensating the variation components (e.g., temperature, and process corner) one at a time. Note that the temperature compensation circuit 1630 can operate in the current domain. Specifically, the temperature compensation circuit 634 can add current (e.g., I_{TCC} 1626) to the output branch 1604 at the node coupling a second terminal of the resistor 1612 and the source of the transistor 1614 to compensate for temperature. It is pointed out that current 1610 (I₁₆₁₀) is the main current of the output branch 1604 and the voltage reference circuit 1600. In various embodiments, the reference voltage 1628 can be bandgap based or based on something else.

In various embodiments, the reference voltage circuit 1600 of FIG. 16 consumes less power than the reference voltage circuit 1000 of FIG. 10. Specifically, in an embodiment, the reference voltage circuit 1000 creates more current resulting in more power consumption. Conversely, the reference voltage circuit 1600 does not consume any more current because it uses the current 1610 of the output branch 1604 to develop the voltage 1624 of the process corner compensation circuit 1616. However, in various embodiments, the reference voltage circuit 1000 can utilize a lower supply voltage (VDD) and can result in a smaller size than the reference voltage circuit 1600.

Within FIG. 16, note that in various embodiments, the CMOS bandgap core circuit 1602 and the temperature compensation circuit 1630 can each be implemented in a wide variety of ways. For example, in various embodiments, the CMOS bandgap core circuit 200 of FIG. 2 can be utilized for implementing the CMOS bandgap core circuit 1602, but is not limited to such. Moreover, in various embodiments, the temperature compensation circuit 500 of FIG. 5 can be utilized for implementing the temperature compensation circuit 1630, but is not limited to such.

In various embodiments, it is pointed out that the voltage reference circuit 1600 can be implemented in any application-specific integrated circuit (ASIC), system-on-chip (SoC), voltage regulator circuit, analog to digital (ADC) circuit, or any integrated circuit, but is not limited to such.

Within FIG. 16, in an embodiment, the reference voltage circuit 1600 can include the CMOS bandgap core 1602, the temperature compensation circuit 1630, the output branch 1604, and the process corner compensation circuit 1616, but is not limited to such. Note that the output branch 1604 can be implemented to include the process corner compensation circuit 1616. The output branch 1604 can be coupled with the CMOS bandgap core 1602 and the temperature compensation circuit 1630. Note that the gate of the transistor 1608 of the output branch 1604 can be coupled to the CMOS bandgap core 1602 and the source of the transistor 1608 can be coupled to VDD 1606. Furthermore, the drain of the transistor 1608 can be coupled to a first terminal of the resistor 1612, an input to the temperature compensation circuit 1630, and the reference voltage output 1632 of the reference voltage circuit 1600. In addition, a second terminal of the resistor 1612 can be coupled to the source of the transistor 1614 and the output of the temperature compensation circuit 1630. The gate, drain, and body of the transistor 1614 can be coupled to the process corner compensation circuit 1616. The process corner compensation circuit 1616 can be coupled to ground 1618.

Note that each of transistors 1608 and 1614 can be implemented in a wide variety of ways. In an embodiment, each of the transistors 1608 and 1614 can be implemented as, but is not limited to, a P-channel MOSFET which is also known as a PMOS. Moreover, in an embodiment, each of the transistors 1608 and 1614 can be implemented as, but is not limited to, an N-channel MOSFET which is also known as an NMOS. It is pointed out that each of the transistors 1608 and 1614 can be referred to as a switching element. In an embodiment, note that a gate, a drain, and a source of the transistors 1608 and 1614 can each be referred to as a terminal of its transistor. Additionally, in an embodiment, each gate of the transistors 1608 and 1614 can also be referred to as a control terminal of its transistor.

It is pointed out that the reference voltage circuit 1600 may not include all of the elements illustrated by FIG. 16. Furthermore, the reference voltage circuit 1600 can be implemented to include one or more elements not illustrated by FIG. 16. Note that the reference voltage circuit 1600 can be utilized or implemented in any manner similar to that described and/or shown by the present disclosure, but is not limited to such.

FIG. 16A is a schematic diagram of a bandgap or voltage reference circuit 1600A in accordance with various embodiments of the present disclosure. Note that the voltage reference circuit 1600A illustrates that an output of its temperature compensation circuit (e.g., 1631) can be coupled to a different node of the output branch 1604 than that shown within the voltage reference circuit 1600 of FIG. 16. It is noted that the voltage reference circuit 1600A of FIG. 16A operates in a manner similar to the voltage reference circuit 1600 of FIG. 16. However, within the voltage reference circuit 1600A, the temperature compensation circuit 1631 adds current (e.g., I_{TCC} 1627) to the output branch 1604 at the node coupling the drain of the transistor 1608, the first terminal of the resistor 1612, and the reference voltage output 1632 to compensate for temperature.

In an embodiment, an input of the temperature compensation circuit 1631 can be coupled to the output of the CMOS bandgap core 1602 and the gate of the transistor 1608. The output of the temperature compensation circuit 1631 can be coupled to the node coupling the drain of the transistor 1608, the first terminal of the resistor 1612, and the reference voltage output 1632. In various embodiments, the temperature compensation circuit 550 of FIG. 5A can be utilized for implementing the temperature compensation circuit 1631, but is not limited to such. In various embodiments, the remaining components of the voltage reference circuit 1600A can be coupled and implemented in any manner similar to that described and/or shown by the voltage reference circuit 1600 of FIG. 16, but are not limited to such.

Note that the reference voltage circuit 1600A may not include all of the elements illustrated by FIG. 16A. Moreover, the reference voltage circuit 1600A can be implemented to include one or more elements not illustrated by FIG. 16A. It is pointed out that the reference voltage circuit 1600A can be utilized or implemented in any manner similar to that described and/or shown by the present disclosure, but is not limited to such.

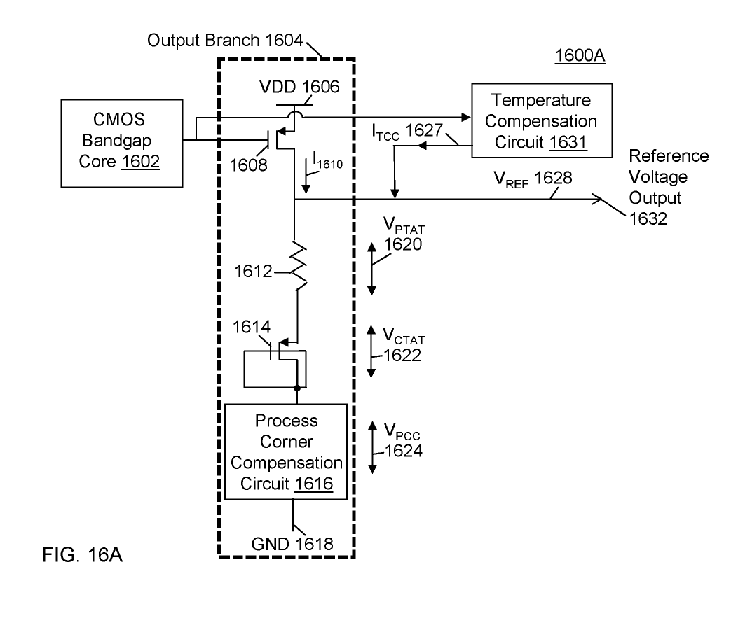

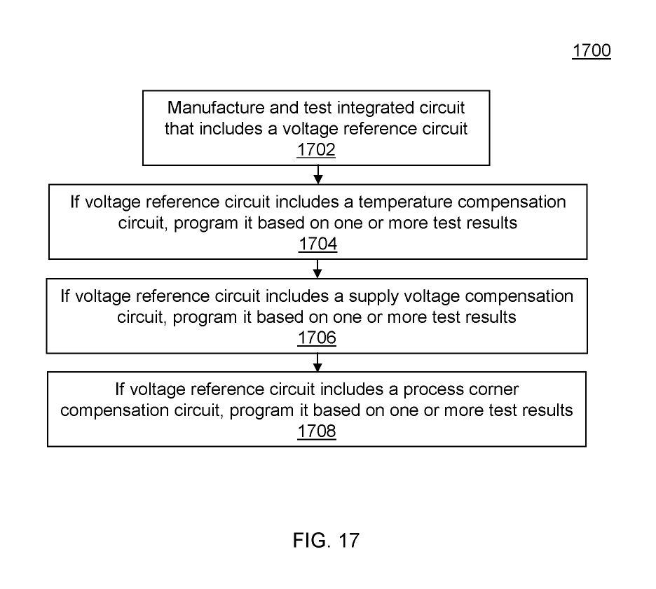

FIG. 17 is a flow diagram of a method 1700 for implementing an integrated circuit including a voltage reference circuit in accordance with various embodiments of the present disclosure. Although specific operations are disclosed in FIG. 17, such operations are examples. The method 1700 may not include all of the operations illustrated by FIG. 17. Also, method 1700 may include various other operations and/or variations of the operations shown. Likewise, the sequence of the operations of flow diagram 1700 can be modified. It is appreciated that not all of the operations in flow diagram 1700 may be performed. In various embodiments, one or more of the operations of method 1700 can be controlled or managed by software, by firmware, by hardware or by any combination thereof, but is not limited to such. Method 1700 can include processes of embodiments of the disclosure which can be controlled or managed by a processor(s) and electrical components under the control of computer or computing device readable and executable instructions (or code). The computer or computing device readable and executable instructions (or code) may reside in the same ASIC or SoC chip as the voltage reference circuit, or in a separate chip, for example, in data storage features such as computer or computing device usable volatile memory (e.g., 1804), or computer or computing device usable non-volatile memory (e.g., 1806), or computer or computing device usable mass data storage (e.g., 1818), or any combination thereof. However, the computer or computing device readable and executable instructions (or code) may reside in any type of computer or computing device readable medium or memory.

At operation 1702, an integrated circuit (e.g., die) can be manufactured and tested that includes a voltage reference circuit (e.g., 100, 100A, 100B, 100C, 600, 600A, 800, 900, 900A, 1000, 1000A, 1000B, 1000C, 1100, 1100A, 1200, 1200A, 1300, 1400, 1500, 1600, or 1600A). It is noted that operation 1702 can be implemented in a wide variety of ways. For example, operation 1702 can be implemented in any manner similar to that described and/or shown by the present disclosure, but is not limited to such.

At operation 1704 of FIG. 17, if the voltage reference circuit includes a temperature compensation circuit (e.g., 134, 135, 500, 550, 634, 635, 1028, 1029, 1228, 1229, 1630, or 1631), the temperature compensation circuit can be programmed (or fixed or encoded) based on one or more test results of operation 1702. Note that operation 1704 can be implemented in a wide variety of ways. For example, operation 1704 can be implemented in any manner similar to that described and/or shown by the present disclosure, but is not limited to such.

At operation 1706, if the voltage reference circuit includes a supply voltage compensation circuit (e.g., 104, 300, 604, 1104, 1304, or 1504), the supply voltage compensation circuit can be programmed (or fixed or encoded) based on one or more test results of operation 1702. It is pointed out that operation 1706 can be implemented in a wide variety of ways. For example, operation 1706 can be implemented in any manner similar to that described and/or shown by the present disclosure, but is not limited to such.

At operation 1708 of FIG. 17, if the voltage reference circuit includes a process corner compensation circuit (e.g., 136, 400, 620, 700, 924, 1030, 1132, 1416, 1520, or 1616), the process corner compensation circuit can be programmed (or fixed or encoded) based on one or more test results of operation 1702. It is noted that operation 1708 can be implemented in a wide variety of ways. For example, operation 1708 can be implemented in any manner similar to that described and/or shown by the present disclosure, but is not limited to such.

Therefore, in this manner the method 1700 can implement an integrated circuit including a voltage reference circuit in accordance with various embodiments of the present disclosure.

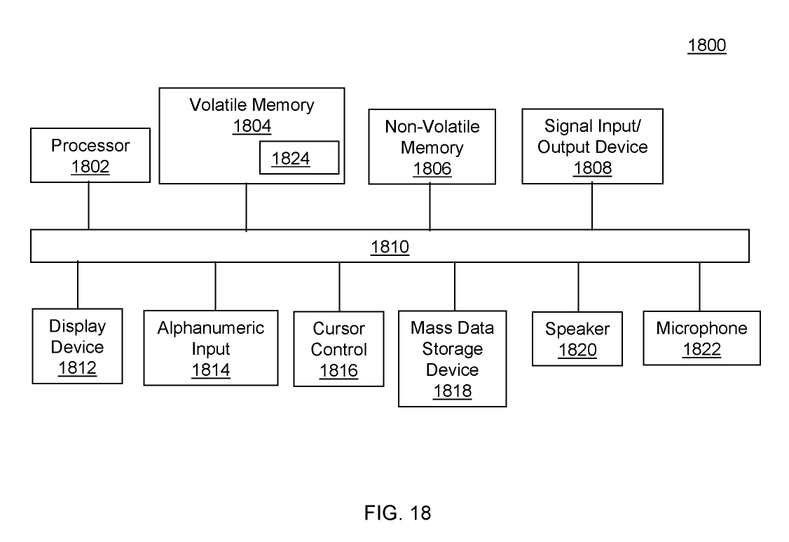

FIG. 18 is a block diagram of an exemplary computing system 1800 that may be used in accordance with various embodiments of the present disclosure. It is understood that system 1800 is not strictly limited to be a computing system. Therefore, system 1800 is well suited to be any type of computing device (e.g., computer system, desktop computer, server computer, database computer system, laptop computer, portable computing device, smartphone, tablet computer, phablet, mobile phone, handheld computing device, wearables and IoT devices, etc.) in accordance with various embodiments of the disclosure. In its various embodiments, system 1800 may not include all of the elements illustrated by FIG. 18, or system 1800 may include other elements not shown by FIG. 18. Within discussions of various embodiments in accordance with the disclosure herein, certain processes and operations are discussed that can be realized, in some embodiments, as a series of instructions (e.g., software program, software code, and the like) that reside within computer readable memory or storage of computing system 1800 and executed by a processor(s) of system 1800. When executed, the instructions can cause computer 1800 to perform specific operations and exhibit specific behavior which are described herein, but are not limited to such.

Computer system 1800 can include an address/data bus 1810 for communicating information, one or more central processors 1802 coupled with bus 1810 for processing information and instructions. Central processor unit(s) 1802 may be a microprocessor or any other type of processor. The computer 1800 can also include data storage features such as computer usable volatile memory 1804, e.g., random access memory (RAM), static RAM, dynamic RAM, etc., coupled with bus 1810 for storing information and instructions for central processor(s) 1802, computer usable non-volatile memory 1806, e.g., read only memory (ROM), programmable ROM, flash memory, erasable programmable read only memory (EPROM), electrically erasable programmable read only memory (EEPROM), etc., coupled with bus 1810 for storing static information and instructions for processor(s) 1802.

System 1800 of FIG. 18 can also include one or more signal generating and receiving devices 1808 coupled with bus 1810 for enabling system 1800 to interface with other electronic devices. The communication interface(s) 1808 of the present embodiment may include wired and/or wireless communication technologies. For example, in one embodiment, the communication interface 1808 is a serial communication port, but could also alternatively be any of a number of well known communication standards and protocols, e.g., a Universal Serial Bus (USB), an Ethernet adapter, a FireWire (IEEE 1394) interface, a parallel port, a small computer system interface (SCSI) bus interface, an infrared (IR) communication port, a Bluetooth wireless communication adapter, a broadband connection, and the like. In an embodiment, a cable or digital subscriber line (DSL) connection may be employed. In such a case the communication interface(s) 1808 may include a cable modem or a DSL modem.

The computer system 1800 can include an alphanumeric input device 1814 including alphanumeric and function keys coupled to the bus 1810 for communicating information and command selections to the central processor(s) 1802. The computer 1800 can also include a cursor control or cursor directing device 1816 coupled to the bus 1810 for communicating user input information and command selections to the processor(s) 1802. The cursor directing device 1816 can be implemented using a number of well known devices such as, but not limited to, a touch pad, a touch screen, a mouse, a tracking device, a track ball, a track pad, etc. Alternatively, it is appreciated that a cursor can be directed and/or activated via input from the alphanumeric input device 1814 using special keys and key sequence commands. The present embodiment is also well suited to directing a cursor by other means such as, for example, voice commands.

Within FIG. 18, the computer system 1800 can also include a computer usable mass data storage device 1818 such as a magnetic or optical disk and disk drive (e.g., hard drive or floppy diskette) coupled with bus 1810 for storing information and instructions. The computer system 1800 can include a display device 1812 coupled to bus 1810 for displaying video and/or graphics. Note that the display device 1812 may be implemented with different technologies. For example, the display device 1812 may be implemented with, but is not limited to, a light emitting diode (LED) display, flat panel liquid crystal display (LCD), field emission display (FED), plasma display, cathode ray tube (CRT), or any other display device suitable for displaying video and/or graphic images and alphanumeric characters recognizable to a user.

The computer system 1800 can also include an audio speaker(s) 1820 coupled with bus 1810 for outputting any type of audio signals or sounds produced by computer system 1800 that may, for example, be heard and/or recognizable to a user. In addition, the computer system 1800 can include an audio microphone(s) 1822 coupled with bus 1810 for receiving and inputting any type of audio signals or sounds into computer system 1800.

Within FIG. 18, note that the volatile memory 1804 may store one or more software programs or code 1824 in accordance with various embodiments of the disclosure. The one or more software programs or code 1824 may include instructions to cause the system 1800 to operate or function in any manner similar to that described herein, but not limited to such. It is pointed out that in various embodiments, the one or more software programs or code 1824 (or one or more of its components) may be stored by the volatile memory 1804, or the non-volatile memory 1806, or the mass data storage device 1818, or any combination thereof.

Within FIG. 18, it is noted that the components associated with computer system 1800 described above may be resident to and associated with one physical computing device. However, one or more of the components associated with computer system 1800 may be physically distributed to other locations and be communicatively coupled together (e.g., via one or more networks).

It is noted that the computer system 1800 may not include all of the elements illustrated by FIG. 18. Furthermore, the computer system 1800 can be implemented to include one or more elements not illustrated by FIG. 18. It is pointed out that the computer system 1800 can be utilized or implemented in any manner similar to that described and/or shown by the present disclosure, but is not limited to such.

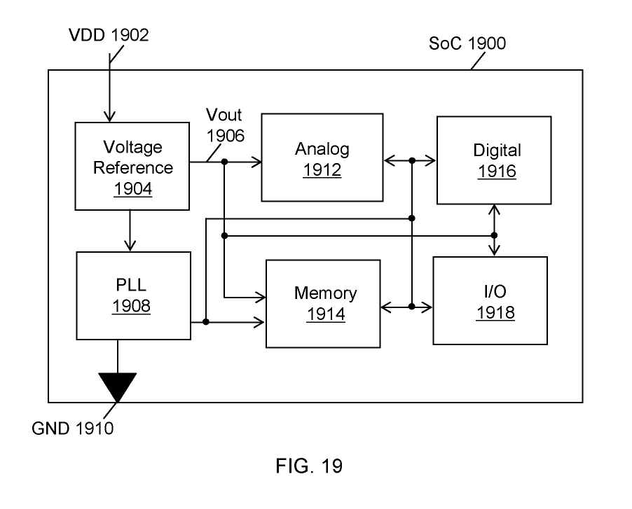

FIG. 19 is a block diagram of an exemplary system-on-chip (SoC) 1900 that may be implemented with a bandgap or voltage reference circuit 1904 in accordance with various embodiments of the present disclosure. For example, in various embodiments, the voltage reference circuit 1904 of the SoC 1900 can be implemented with the bandgap or voltage reference circuit 100, 100A, 100B, 100C, 600, 600A, 800, 900, 900A, 1000, 1000A, 1000B, 1000C, 1100, 1100A, 1200, 1200A, 1300, 1400, 1500, 1600, or 1600A, but is not limited to such.

It is pointed out that the SoC 1900 can include, but is not limited to, the voltage reference circuit 1904, a phase locked loop (PLL) circuit 1908, an analog circuit 1912, a memory circuit 1914, a digital circuit 1916, and an input/output (I/O) circuit 1918. The voltage reference circuit 1904 of the SoC 1900 can be coupled to a supply voltage (VDD) 1902 while its output voltage (Vout) 1906 can be coupled to be received by the analog circuit 1912, the memory circuit 1914, the digital circuit 1916, and the I/O circuit 1918. In addition, the voltage reference circuit 1904 can be coupled to output voltage or current reference signals to the PLL circuit 1908. The PLL circuit 1908 can be coupled to output one or more signals to the analog circuit 1912, the memory circuit 1914, the digital circuit 1916, and the I/O circuit 1918. The PLL circuit 1908 can be coupled to ground (GND) 1910.

It is noted that the SoC 1900 may not include all of the elements illustrated by FIG. 19. Moreover, the SoC 1900 can be implemented to include one or more elements not illustrated by FIG. 19. It is pointed out that the SoC 1900 can be utilized or implemented in any manner similar to that described and/or shown by the present disclosure, but is not limited to such.

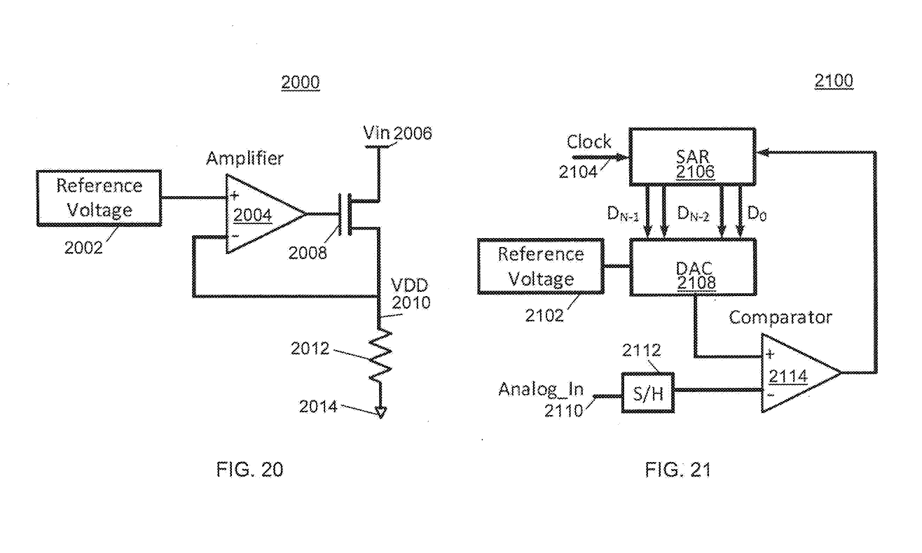

FIG. 20 is an exemplary voltage regulator circuit 2000 that may be implemented with a bandgap or voltage reference circuit 2002 in accordance with various embodiments of the present disclosure. For example, in various embodiments, the voltage reference circuit 2002 of the voltage regulator circuit 2000 can be implemented with the bandgap or voltage reference circuit 100, 100A, 100B, 100C, 600, 600A, 800, 900, 900A, 1000, 1000A, 1000B, 1000C, 1100, 1100A, 1200, 1200A, 1300, 1400, 1500, 1600, or 1600A, but is not limited to such. When implemented in this manner, the voltage regulator circuit 2000 can produce an accurate output supply voltage (VDD) 2010, which can also be referred to as an internal VDD. In an embodiment, the voltage regulator circuit 2000 can be implemented as part of a SoC (e.g., 1900), but is not limited to such.

Note that the voltage regulator circuit 2000 can include, but is not limited to, the voltage reference circuit 2002, an operational amplifier (op-amp) 2004, an NMOS transistor 2008, and a resistor 2012. The output of the voltage reference circuit 2002 can be coupled to the non-inverting input (+) of the operational amplifier 2004 while the output of the operational amplifier 2004 can be coupled to the gate of the transistor 2008. In addition, the inverting input (−) of the operational amplifier 2004 can be coupled to the source of the transistor 2008 and a first terminal of the resistor 2012. The drain of the transistor 2008 can be coupled to an external voltage supply (Vin) 2006 while a second terminal of the resistor 2012 can be coupled to ground 2014. In an embodiment, the output supply voltage (VDD) 2010 of the voltage regulator circuit 2000 can be output at the coupling of the first terminal of the resistor 2012, the source of the transistor 2008, and the inverting input (−) of the operational amplifier 2004.

It is pointed out that the voltage regulator circuit 2000 may not include all of the elements illustrated by FIG. 20. Additionally, the voltage regulator circuit 2000 can be implemented to include one or more elements not illustrated by FIG. 20. Note that the voltage regulator circuit 2000 can be utilized or implemented in any manner similar to that described and/or shown by the present disclosure, but is not limited to such. For example, in an embodiment, the transistor 2008 can be a PMOS transistor. In that case, the op-amp input nodes (inverting input and non-inverting input) are swapped.

FIG. 21 is an exemplary analog to digital converter (ADC) circuit 2100 that may be implemented with a bandgap or voltage reference circuit 2102 in accordance with various embodiments of the present disclosure. For example, in various embodiments, the voltage reference circuit 2102 of the ADC circuit 2100 can be implemented with the bandgap or voltage reference circuit 100, 100A, 100B, 100C, 600, 600A, 800, 900, 900A, 1000, 1000A, 1000B, 1000C, 1100, 1100A, 1200, 1200A, 1300, 1400, 1500, 1600, or 1600A, but is not limited to such. In an embodiment, the ADC circuit 2100 can be implemented as part of a SoC (e.g., 1900), but is not limited to such.

It is noted that the ADC circuit 2100 can include, but is not limited to, the voltage reference circuit 2102, a SAR (Successive Approximation Register) 2106, a digital to analog converter (DAC) circuit 2108, a sample and hold (S/H) circuit 2112, and a comparator 2114. The output of the voltage reference circuit 2102 can be coupled to an input of the DAC 2108 while a first input of the SAR 2106 can be coupled to receive a clock signal (Clock) 2104. Outputs (e.g., D_{N-1}, D_{N-2}, D₀) of the SAR 2106 can be coupled to be received by the DAC circuit 2108 while an output of the DAC circuit 2108 can be coupled to a first input (+) of the comparator 2114. The input of the S/H circuit 2112 can be coupled to received an analog voltage input signal (Analog_In) 2110 while an output of the S/H circuit 2112 can be coupled to a second input (−) of the comparator 2114. The output of the comparator 2114 can be coupled to a second input of the SAR 2106.

Note that the ADC circuit 2100 may not include all of the elements illustrated by FIG. 21. Furthermore, the ADC circuit 2100 can be implemented to include one or more elements not illustrated by FIG. 21. It is pointed out that the SAR ADC circuit 2100 can be utilized or implemented in any manner similar to that described and/or shown by the present disclosure, but is not limited to such. For example, various ADC architectures including pipeline ADC, sigma delta ADC, flash ADC, single slope ADC, etc. can be implemented with a bandgap or voltage reference circuit 2102 in accordance with various embodiments of the present disclosure.

It is pointed out that the phase “coupled to” as used herein may include, but is not limited to, a connection that includes one or more intervening components or a direct physical connection with no intervening components.

The foregoing descriptions of various specific embodiments in accordance with the present disclosure have been presented for purposes of illustration and description. They are not intended to be exhaustive or to limit the present disclosure to the precise forms disclosed, and many modifications and variations are possible in light of the above teaching. The present disclosure is to be construed according to the Claims and their equivalents.

What is claimed is:

1. A voltage reference circuit comprising:
a core circuit; and
an output branch circuit coupled to said core circuit;
said voltage reference circuit is free of bipolar junction transistors.

2. The voltage reference circuit of claim 1, further comprising:
a process corner compensation circuit coupled to said output branch circuit.

3. The voltage reference circuit of claim 2, further comprising:
a temperature compensation circuit coupled to said output branch circuit.

4. The voltage reference circuit of claim 2, further comprising:
a supply voltage compensation circuit coupled to said output branch circuit.

5. The voltage reference circuit of claim 4, further comprising:
a temperature compensation circuit coupled to said output branch circuit.

6. The voltage reference circuit of claim 1, further comprising:
a supply voltage compensation circuit coupled to said output branch circuit.

7. The voltage reference circuit of claim 1, further comprising:
a temperature compensation circuit coupled to said output branch circuit.

8. A voltage reference circuit comprising:
a bandgap core circuit;
an output branch circuit coupled to said bandgap core circuit; and
a process corner compensation circuit coupled to said output branch circuit;
said voltage reference circuit is free of bipolar junction transistors.

9. The voltage reference circuit of claim 8, further comprising:
a temperature compensation circuit coupled to said output branch circuit.

10. The voltage reference circuit of claim 8, further comprising:
a supply voltage compensation circuit coupled to said output branch circuit.

11. The voltage reference circuit of claim 10, further comprising:
a temperature compensation circuit coupled to said output branch circuit.

12. The voltage reference circuit of claim 8, wherein said process corner compensation circuit is programmable.

13. The voltage reference circuit of claim 8, further comprising:
a temperature compensation circuit coupled to said output branch circuit, said temperature compensation circuit is programmable.

14. The voltage reference circuit of claim 8, further comprising:
a supply voltage compensation circuit coupled to said output branch circuit, said supply voltage compensation circuit is programmable.

15. A voltage reference circuit comprising:
a core circuit; and
an output branch circuit coupled to said core circuit, said output branch circuit comprises a process corner compensation circuit;
said voltage reference circuit is free of bipolar junction transistors.

16. The voltage reference circuit of claim 15, further comprising:
a temperature compensation circuit coupled to said output branch circuit.

17. The voltage reference circuit of claim 15, further comprising:
a supply voltage compensation circuit coupled to said output branch circuit.

18. The voltage reference circuit of claim 17, further comprising:
a temperature compensation circuit coupled to said output branch circuit.

19. The voltage reference circuit of claim 15, wherein said process corner compensation circuit comprises a programmable switch.

20. The voltage reference circuit of claim 15, wherein said core circuit comprises a bandgap core circuit.
